(19) United States
(12) Patent Application Publication
(10) Pub. No.: US 2025/0192859 A1
(43) Pub. Date: Jun. 12, 2025

(54) ASSISTED BEAM MANAGEMENT

(71) Applicant: QUALCOMM Incorporated, San Diego, CA (US)

(72) Inventors: Soumya DAS, San Diego, CA (US); Mohammad NEKOUI, Escondido, CA (US); Bala RAMASAMY, San Marcos, CA (US)

(21) Appl. No.: 18/533,131

(22) Filed: Dec. 7, 2023

(51) Int. Cl. H04B 7/06; H04W 4/029; H04W 4/40

(52) U.S. Cl. CPC H04B 7/06952; H04W 4/029; H04W 4/40

(57) ABSTRACT

Methods, systems, and devices for wireless communications are described. A first device may receive a first message indicating location information of a second device. The first device may obtain map information corresponding to a geographic area associated with the location information. The first device may perform a beam sweeping procedure to determine beams to be used for communication with the second device. The first device may communicate with the second device using the determined beams. Additionally, or alternatively, a first device may receive a first message including intersection information that includes beam information associated with the intersection. The first device may perform, with a second device, a beam sweeping procedure to determine, based on the intersection information, beams to be used for communication with the second device. The first device may communicate with the second device using the determined beams.

### FIELD OF TECHNOLOGY

The following relates to wireless communications, including assisted beam management.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, a wireless device may perform a beam sweeping procedure. However, such approaches may be improved.

### SUMMARY

The described techniques relate to improved methods, systems, devices, and apparatuses that support assisted beam management. For example, a first wireless device may receive, over a first frequency band, a first vehicle safety message indicating location information of a second wireless device. The first wireless device may obtain map information corresponding to a geographic area associated with the location information. The first wireless device may perform, with the second wireless device over a second frequency band that differs from the first frequency band, a beam sweeping procedure using a first subset of beams from a plurality of available beams to determine, based at least in part on the location information and the map information, one or more beams of the first subset of beams to be used for communication with the second wireless device. The first wireless device may communicate, over the second frequency band, one or more messages with the second wireless device using the one or more beams of the first subset of beams.

Additionally, or alternatively, a first wireless device may receive, over a first frequency band, a first vehicle safety message including intersection information associated with an intersection comprising a plurality of lanes, where the intersection information includes beam direction information associated with a subset of the plurality of lanes. The first wireless device may perform, with a second wireless device over a second frequency band that differs from the first frequency band, a beam sweeping procedure using a first subset of beams from a plurality of available beams to determine, based on the intersection information, one or more beams of the first subset of beams to be used for communication with the second wireless device. The first wireless device may communicate, over the second frequency band, one or more messages with the second wireless device using the one or more beams of the first subset of beams.

A method for wireless communications by a first wireless device is described. The method may include receiving, over a first frequency band, a first vehicle safety message indicating location information of a second wireless device, obtaining map information corresponding to a geographic area associated with the location information, performing, with the second wireless device over a second frequency band that differs from the first frequency band, a beam sweeping procedure using a first subset of beams from a set of multiple available beams to determine, based on the location information and the map information, one or more beams of the first subset of beams to be used for communication with the second wireless device, and communicating, over the second frequency band, one or more messages with the second wireless device using the one or more beams of the first subset of beams.

A first wireless device for wireless communications is described. The first wireless device may include one or more memories storing processor executable code, and one or more processors coupled with the one or more memories. The one or more processors may individually or collectively operable to execute the code to cause the first wireless device to receive, over a first frequency band, a first vehicle safety message indicating location information of a second wireless device, obtain map information corresponding to a geographic area associated with the location information, perform, with the second wireless device over a second frequency band that differs from the first frequency band, a beam sweeping procedure using a first subset of beams from a set of multiple available beams to determine, based on the location information and the map information, one or more beams of the first subset of beams to be used for communication with the second wireless device, and communicate, over the second frequency band, one or more messages with the second wireless device using the one or more beams of the first subset of beams.

Another first wireless device for wireless communications is described. The first wireless device may include means for receiving, over a first frequency band, a first vehicle safety message indicating location information of a second wireless device, means for obtaining map information corresponding to a geographic area associated with the location information, means for performing, with the second wireless device over a second frequency band that differs from the first frequency band, a beam sweeping procedure using a first subset of beams from a set of multiple available beams to determine, based on the location information and the map information, one or more beams of the first subset of beams to be used for communication with the second wireless device, and means for communicating, over the second frequency band, one or more messages with the second wireless device using the one or more beams of the first subset of beams.

A non-transitory computer-readable medium storing code for wireless communications is described. The code may include instructions executable by one or more processors to receive, over a first frequency band, a first vehicle safety message indicating location information of a second wireless device, obtain map information corresponding to a geographic area associated with the location information, perform, with the second wireless device over a second frequency band that differs from the first frequency band, a beam sweeping procedure using a first subset of beams from a set of multiple available beams to determine, based on the location information and the map information, one or more beams of the first subset of beams to be used for communication with the second wireless device, and communicate, over the second frequency band, one or more messages with the second wireless device using the one or more beams of the first subset of beams.

Some examples of the method, first wireless devices, and non-transitory computer-readable medium described herein may further include operations, features, means, or instructions for receiving, over the first frequency band from the second wireless device, a first message including intersection information associated with an intersection including a set of multiple lanes, where the intersection information includes beam direction information associated with a subset of the set of multiple lanes and where performing the beam sweeping procedure may be based on the intersection information.

Some examples of the method, first wireless devices, and non-transitory computer-readable medium described herein may further include operations, features, means, or instructions for receiving the map information from the second wireless device.

In some examples of the method, first wireless devices, and non-transitory computer-readable medium described herein, the first wireless device may be an on-board unit (OBU) and the second wireless device may be a network entity co-located with a road-side unit.

In some examples of the method, first wireless devices, and non-transitory computer-readable medium described herein, the first wireless device may be a first on-board unit (OBU) associated with a first vehicle and the second wireless device may be a second OBU associated with a second vehicle.

In some examples of the method, first wireless devices, and non-transitory computer-readable medium described herein, the first frequency band may be an intelligent transportation system (ITS) band.

In some examples of the method, first wireless devices, and non-transitory computer-readable medium described herein, the second frequency band may be a millimeter wave band.

A method for wireless communications by a first wireless device is described. The method may include receiving, over a first frequency band, a first vehicle safety message including intersection information associated with an intersection including a set of multiple lanes, where the intersection information includes beam direction information associated with a subset of the set of multiple lanes, performing, with a second wireless device over a second frequency band that differs from the first frequency band, a beam sweeping procedure using a first subset of beams from a set of multiple available beams to determine, based on the intersection information, one or more beams of the first subset of beams to be used for communication with the second wireless device, and communicating, over the second frequency band, one or more messages with the second wireless device using the one or more beams of the first subset of beams.

A first wireless device for wireless communications is described. The first wireless device may include one or more memories storing processor executable code, and one or more processors coupled with the one or more memories. The one or more processors may individually or collectively operable to execute the code to cause the first wireless device to receive, over a first frequency band, a first vehicle safety message including intersection information associated with an intersection including a set of multiple lanes, where the intersection information includes beam direction information associated with a subset of the set of multiple lanes, perform, with a second wireless device over a second frequency band that differs from the first frequency band, a beam sweeping procedure using a first subset of beams from a set of multiple available beams to determine, based on the intersection information, one or more beams of the first subset of beams to be used for communication with the second wireless device, and communicate, over the second frequency band, one or more messages with the second wireless device using the one or more beams of the first subset of beams.

Another first wireless device for wireless communications is described. The first wireless device may include means for receiving, over a first frequency band, a first vehicle safety message including intersection information associated with an intersection including a set of multiple lanes, where the intersection information includes beam direction information associated with a subset of the set of multiple lanes, means for performing, with a second wireless device over a second frequency band that differs from the first frequency band, a beam sweeping procedure using a first subset of beams from a set of multiple available beams to determine, based on the intersection information, one or more beams of the first subset of beams to be used for communication with the second wireless device, and means for communicating, over the second frequency band, one or more messages with the second wireless device using the one or more beams of the first subset of beams.

A non-transitory computer-readable medium storing code for wireless communications is described. The code may include instructions executable by one or more processors to receive, over a first frequency band, a first vehicle safety message including intersection information associated with an intersection including a set of multiple lanes, where the intersection information includes beam direction information associated with a subset of the set of multiple lanes, perform, with a second wireless device over a second frequency band that differs from the first frequency band, a beam sweeping procedure using a first subset of beams from a set of multiple available beams to determine, based on the intersection information, one or more beams of the first subset of beams to be used for communication with the second wireless device, and communicate, over the second frequency band, one or more messages with the second wireless device using the one or more beams of the first subset of beams.

Some examples of the method, first wireless devices, and non-transitory computer-readable medium described herein may further include operations, features, means, or instructions for receiving, over the first frequency band, a second vehicle safety message indicating location information of the second wireless device, obtaining map information corresponding to a geographic area associated with the location information, and where performing the beam sweeping procedure may be based on the location information and the map information.

In some examples of the method, first wireless devices, and non-transitory computer-readable medium described herein, the first vehicle safety message may be a signal phase and time message, a map data message, or a road geometry attributes message.

In some examples of the method, first wireless devices, and non-transitory computer-readable medium described herein, the first vehicle safety message includes a beam quantity parameter indicating a set of multiple beams, a beam azimuth angle parameter for each beam of the set of multiple beams, a beam elevation parameter for each beam of the set of multiple beams, a current beam parameter for the subset of the set of multiple lanes, or any combination thereof.

In some examples of the method, first wireless devices, and non-transitory computer-readable medium described herein, the current beam parameter may be associated with a lane connection parameter that may be associated with the subset of the set of multiple lanes, where performing the beam sweeping procedure may be based on the current beam parameter.

Some examples of the method, first wireless devices, and non-transitory computer-readable medium described herein may further include operations, features, means, or instructions for performing the beam sweeping procedure based on the subset of the set of multiple lanes corresponding to a first vehicle associated with the first wireless device, where the subset of the set of multiple lanes corresponds to the first subset of beams.

In some examples of the method, first wireless devices, and non-transitory computer-readable medium described herein, the first vehicle safety message includes a set of multiple identifiers associated with the set of multiple available beams and the one or more beams of the first subset of beams may be determined based on corresponding identifiers of the set of multiple identifiers.

In some examples of the method, first wireless devices, and non-transitory computer-readable medium described herein, the first wireless device may be an on-board unit (OBU) and the second wireless device may be a network entity co-located with a road-side unit.

In some examples of the method, first wireless devices, and non-transitory computer-readable medium described herein, the first vehicle safety message indicates a public land mobile network (PLMN) identifier associated with the second wireless device.

In some examples of the method, first wireless devices, and non-transitory computer-readable medium described herein, the first frequency band may be an intelligent transportation system (ITS) band.

In some examples of the method, first wireless devices, and non-transitory computer-readable medium described herein, the second frequency band may be a millimeter wave band.

### BRIEF DESCRIPTION OF THE DRAWINGS

FIG. 1 shows an example of a wireless communications system that supports assisted beam management in accordance with one or more aspects of the present disclosure.

FIG. 2 shows an example of a wireless communications system that supports assisted beam management in accordance with one or more aspects of the present disclosure.

FIG. 3 shows an example of a wireless communications system that supports assisted beam management in accordance with one or more aspects of the present disclosure.

FIG. 4 shows an example of a process flow that supports assisted beam management in accordance with one or more aspects of the present disclosure.

FIG. 5 shows an example of a process flow that supports assisted beam management in accordance with one or more aspects of the present disclosure.

FIG. 6 shows an example of a wireless communications system that supports assisted beam management in accordance with one or more aspects of the present disclosure.

FIG. 7 shows an example of a process flow that supports assisted beam management in accordance with one or more aspects of the present disclosure.

FIG. 8 shows an example of a process flow that supports assisted beam management in accordance with one or more aspects of the present disclosure.

FIGS. 9 and 10 show block diagrams of devices that support assisted beam management in accordance with one or more aspects of the present disclosure.

FIG. 11 shows a block diagram of a communications manager that supports assisted beam management in accordance with one or more aspects of the present disclosure.

FIG. 12 shows a diagram of a system including a device that supports assisted beam management in accordance with one or more aspects of the present disclosure.

FIGS. 13 and 14 show flowcharts illustrating methods that support assisted beam management in accordance with one or more aspects of the present disclosure.

### DETAILED DESCRIPTION

Wireless communications devices may communicate using mmWave communications that may involve predicting current and future beam indices to be used for communications in both wireless wide area network (WWAN) communications as well as in sidelink communications. Determining narrow beams to be used for communications may involve prohibitively large beam training overhead which consumes compute resources and incurs latency cost. Further, for high mobility applications (e.g., vehicle to everything (V2X) communications), this becomes more challenging since the channel may change rapidly and beam training may be performed more frequently.

In some examples, a first wireless device (e.g., an on-board unit) may communicate with a second wireless device (e.g., a road-side unit (RSU) in a WWAN scenario or another OBU in a sidelink scenario) and may receive location information associated with the first wireless device (e.g., a geo-location, GPS coordinates, a relative position of the first wireless device, or the like) that may be overlayed with map information (e.g., pre-loaded map information, received map information, dynamic map information, or any combination thereof). The first wireless device, the second wireless device, or both, may select one or more beams to be used for a beam sweeping procedure based on the location information and the map information and may exclude one or more beams that may not be effective for communications given the location information and map information. Such a beam sweeping procedure may be performed over an access link, a PC5 link, one or more other communication links, or any combination thereof. The first wireless device and the second wireless device may then perform the beam sweeping procedure over this improved set of beams to select or identify beams to be used for communications.

Additionally, or alternatively, in some examples, the second wireless device may transmit messaging (e.g., a signal phase and time (SPaT), a map data (MAP) message, one or more other messages, or any combination thereof) that may include information associated with a traffic intersection as well as beam information associated with a subset of lanes comprised in or associated with the traffic intersection. The first wireless device, the second wireless device, or both may exclude one or more beams from the available beams based on the beam information included in the messaging and may perform the beam sweeping procedure.

As a result of such augmented beam management, latency (e.g., synchronization latency, connection latency, or beam alignment latency) may be reduced as the beam sweeping procedure may consider fewer beams selected based on the location information (e.g., as compared to a set of beams selected without considering the location information). Further, processing overhead or workload and power consumption may be reduced.

Aspects of the disclosure are initially described in the context of wireless communications systems. Aspects of the disclosure are then described with reference to wireless communications systems and process flows. Aspects of the disclosure are further illustrated by and described with reference to apparatus diagrams, system diagrams, and flowcharts that relate to assisted beam management.

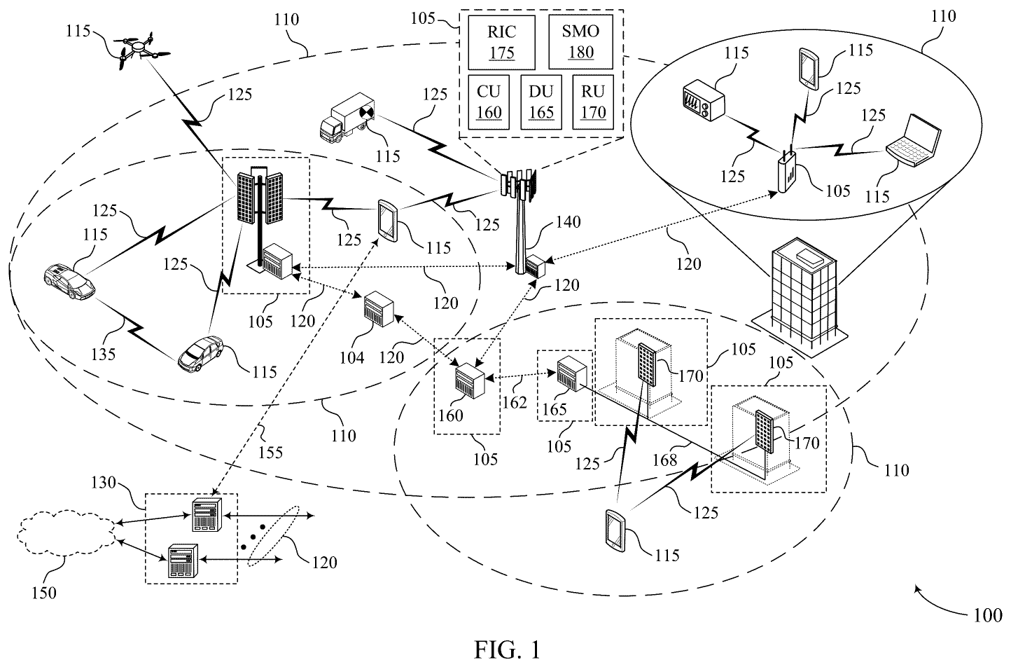

FIG. 1 shows an example of a wireless communications system 100 that supports assisted beam management in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support assisted beam management as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and Ne may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

For example, a wireless device (e.g., an OBU or a UE) may receive location information and may overlay map information with the location information to aid in performing a beam sweeping procedure (e.g., to reduce a quantity of beams that are to be swept during the beam sweeping procedure). Additionally, or alternatively, a wireless device may receive intersection information (e.g., in a SPAT message or MAP message) that may include beam information (e.g., beam direction information or other information about one or more beams associated with the intersection) that may aid in performing a beam sweeping procedure (e.g., to reduce a quantity of beams that are to be swept during the beam sweeping procedure).

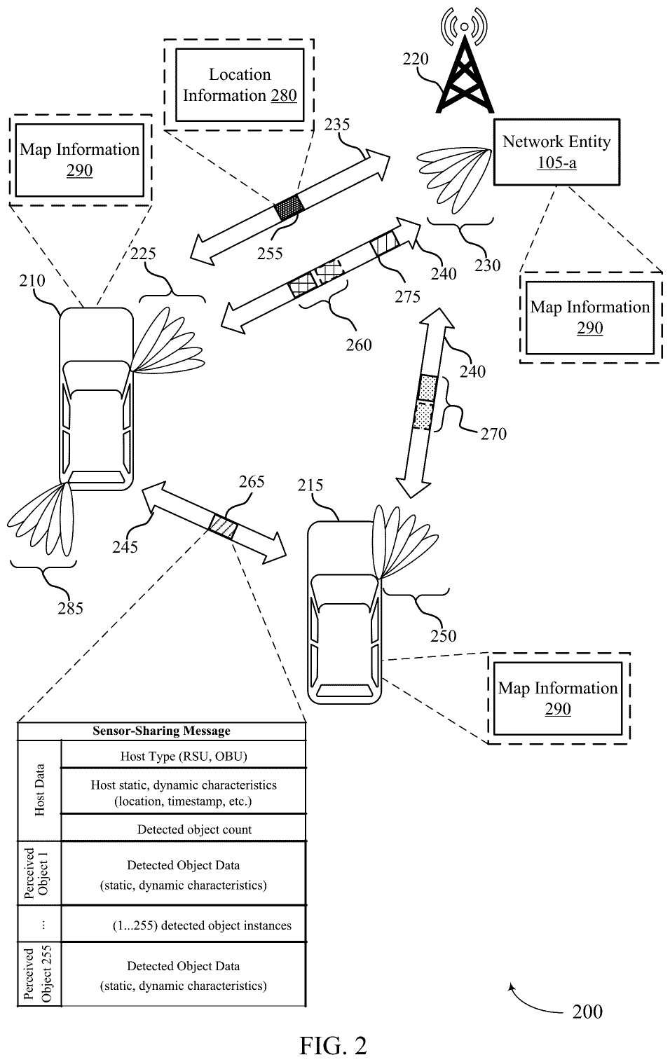

FIG. 2 shows an example of a wireless communications system 200 that supports assisted beam management in accordance with one or more aspects of the present disclosure.

In WWAN communications (e.g., involving mm Wave communications), wireless devices may predict the current and future beam indexes to be used for communications. However, determining beams to use for communications may involve prohibitively large beam training overhead which consumes compute resources and incurs latency cost. Further, for high mobility applications, beam prediction or management may involve additional challenges due to the channel rapidly changing and more frequently performed beam training.

Some approaches use sensing information of the environment (e.g., through camera, LiDAR, or other environmental sensing) to reduce the training overhead. For example, a wireless device may predict one or more beams using sensory input from same time step or may predict one or more future beams using sensory input from previous time steps.

However, such approaches may be improved by utilizing location information in vehicle safety messages (e.g., vehicle to vehicle (V2V) messages or vehicle to infrastructure (V2I) messages) exchanged between one or more OBUs, one or more RSUs, one or more network entities co-located with one or more RSUs, or any combination thereof, to further reduce the training overhead for WWAN beam prediction and tracking. Once such information is obtained and beams are selected or predicted, such obtained beam information may be transmitted to a trailing OBU (or an OBU in any position, such as a position relative to the first wireless device or in a position next to the first wireless device) to further reduce overhead for that OBU as well.

For example, the RSU 220 that is co-located with the network entity 105-a may communicate with the first OBU 210, which may be associated with a vehicle. In some examples, such communications may be performed over a first channel 235, which may be associated with an ITS band. Such communications may aid in facilitating beam management for communications between the OBU 210 and the network entity 105-a. In some examples, the various wireless devices (e.g., the first OBU 210, the second OBU 215, the RSU 220, the network entity 105-a, or any combination thereof) may include multiple antenna elements or arrays to communicate via different bands, such as an ITS band (e.g., with which the first channel 235 may be associated) and a mmWave band (e.g., with which the second channel 240 may be associated).

In some examples, the first OBU 210 may receive (e.g., from the RSU 220 over the first channel 235 which may be associated with an ITS band, such as a 5.9 GHZ band) a first vehicle safety message 255 (e.g., a V2I or I2V message) that may include location information 280 associated with the RSU 220, the co-located network entity 105-a, or both). The location information 280 included may allow for more efficient beam management for communications over the second channel 240 (e.g., which may be associated with a mmWave band or FR2 band).

For example, the first OBU 210 and the network entity 105-a may perform a beam sweeping procedure that may be based on the location information received over the first channel 235 in the first vehicle safety message. The first OBU 210 and the network entity 105-a may employ beam sweeps including beams (e.g., the beams 225, the beams 230, or both) that are oriented towards one or more locations indicated in the location information 280 (e.g., only a subset of available beams of the first OBU 210 are used in a beam sweeping procedure, where beams in the beam subset are oriented in the direction of the location information 280, and other beams of the available beams are excluded from the beam sweeping procedure). The beam subset may include beams occurring within one or more sectors of a sphere, or within an azimuth range corresponding to the location information 280, or with an elevation range corresponding to the location information 280, and may exclude other available beams. For example, beams pointed in a different direction, such as beams 285 of the first OBU 210, may be excluded from the beam sweeping procedure. The network entity 105-a and the OBU 215 may similarly have one or more beams pointed in directions that are oriented away from a desired direction, and may also be excluded from the beam sweeping procedure. As part of the beam sweeping procedure, the beams 225 and the beams 230 may be swept individually to determine which beams of the beams 225 and the beams 230 are to be used for communications between the first OBU 210 and the network entity 105-a (e.g., for communicating the one or more first messages 260).

The use of such location information 280 during an initial access procedure may reduce synchronization and connection latency as well as processor workload. Further, power consumption may be reduced at one or more of the devices (e.g., OBUs, RSUs, network entities, a small cell RSU/gNB, or any combination thereof).

Further, the first OBU 210 may transmit path prediction information to the network entity 105-a or the RSU 220, optionally in a basic safety message (BSM). Such path prediction information may include one or more predicted positions of the first OBU 210 or an associated vehicle at one or more points in time. The network entity 105-a may use the path prediction information for finer beam tracking, such as by refining the beam sweeping procedure (e.g., by selecting one or more beams that may correspond to the prediction information or positions indicated therein).

In some examples, the first OBU 210 may be associated with an autonomous vehicle. In such examples, the autonomous vehicle or first OBU 210 may transmit a path trajectory to the network entity 105-a to similarly improve the beam sweeping procedure (e.g., by allowing the network entity 105-a to select beams for the beam sweeping procedure that correspond to the path trajectory transmitted by the first OBU 210).

In some examples, the network entity 105-a may transmit an indication of a future beam selection 275 of the beams 225, the beams 230, or both, that are associated with one or more future points in time. The first OBU 210 may use the information of the beam selection 275 to further reduce the complexity of the beam sweeping procedure (e.g., by reducing the pool of beams that are to be swept in the beam sweeping procedure) and allow for better beam tracking.

In some examples, the first OBU 210 may transmit (e.g., over the third channel 245, which may be associated with a mmWave band) a sensor data sharing message (SDSM) or a collective perception message (CPM), such as the SDSM/CPM 265 (which may be either an SDSM or a CPM) to the second OBU 215 that may be associated with a second vehicle (e.g., a trailing vehicle or a vehicle in any position, such as a position relative to the first OBU 210 or in a position next to the first wireless device). In some examples, instead of an SDSM or CPM, the first OBU 210 may transmit another type of signaling or messaging that may perform similar functions or carry similar information described herein in relation to the SDSM or CPM. Additionally, or alternatively, the first OBU 210 may transmit information associated with the network entity 105-a, such as a quantity of beams, a geo-location, one or more services provided by the network entity 105-a, other information associated with the network entity 105-a, or any combination thereof. Further, the SDSM/CPM 265 may also include information associated with the first OBU 210, such as a location of the first OBU 210. Use of SDSM/CPM may be beneficial if RSU 220 is collocated with the network entity 105-a where the network entity 105-a is not transmitting I2V messages that include location information of the network entity 105-a. In some examples, a trailing vehicle may adjust its driving path accordingly (e.g., to end up in a good coverage zone for the network entity 105-a).

The second OBU 215 may use the information in the SDSM/CPM 265 to more efficiently select beams for and perform the beam sweeping procedure. For example, the second OBU 215 may select one or more beams (e.g., of the beams 250, the beams 230, or both) that may correspond with the location of the network entity 105-a or that correspond with the beams determined through the beam sweeping procedure between the first OBU 210 and the network entity 105-a (e.g., one or more of the beams 230). In this way, the second OBU 215 may perform its own beam sweeping procedure with the network entity 105-a with reduced synchronization and connection latency, processor workload, and power consumption. The second OBU 215 may then communicate the one or more second message 270 with the network entity 105-a using the one or more beams (e.g., that were selected or determined) as a result of the beam sweeping procedure between the second OBU 215 and the network entity 105-a.

Such use of the SDSM/CPM 265 may be particularly useful in situations in which the RSU 220 that is co-located with the network entity 105-a is not transmitting the first vehicle safety message 255 or is no including the location information 280 in the first vehicle safety message 255. Thus, even if the first OBU 210 does not use the location information 280 during its beam sweeping procedure with the network entity 105-a, the second OBU 215 may utilize the results (e.g., a beam selection) of the beam sweeping procedure between the first OBU 210 and the network entity 105-a to reduce latency, overhead, and power consumption during the beam sweeping procedure between the second OBU 215 and the network entity 105-a.

In some examples, the second vehicle associated with the second OBU 215 may alter a driving path based on the SDSM/CPM 265. For example, the second vehicle may adjust its driving path to better travel through a coverage zone of the network entity 105-a, thereby improving the beam sweeping procedure between the second OBU 215 and the network entity 105-a, as well as the communications performed using the beams determined or selected during the beam sweeping procedure (e.g., communicating the one or more second messages 270).

In some examples, an SDSM, CPM, or other signaling may include source data, detected object data or both. In some examples, the SDSM/CPM 265 may include information or parameters in the host data, such as the following example sensor sharing message that may include the MmWave parameter. This parameter or sequence, one or more other parameters or sequences, or both may indicate the information associated with the network entity 105-a, such as a quantity of beams, a location, one or more services provided by the network entity 105-a, other information associated with the network entity 105-a, or any combination thereof.

```
SensorSharingMsg ::= SEQUENCE {
      msgCnt MsgCount, -- Sequence number
      sourceVehicleID TemporaryID -- temporary vehicle ID/RSU ID. SDSM source.
      equipmentType -- Sender type
      sDSMTimestamp -- SDSM transmission time
      refPos Position3D, -- Sender reference position
      refPosXYConf PositionalAccuracy
      refPosElConf ElevationConfidence OPTIONAL
        vehOrientation VehicleOrientationAngle
        orientationConfidence HeadingConfidence
        MmWave MmWaveData OPTIONAL, -- mmWave data (for RSU)
      objCount DetectedObjectCount, -- Number of reported detections
      objects DetectedObjectList, -- detected objects
.
}
```

In some examples, the MmWaveData parameter or sequence may include information such as the information included in the following example MmWaveData parameter or sequence.

```
DetectedMm WaveData ::= SEQUENCE {
      Array of beams beamNum OPTIONAL,
      Array_azimuth_angle_per_beam beamAzimuth OPTIONAL,
      Array_elevation_angle_per_beam beamElevation OPTIONAL,
      Array_current_gNB_beam_for_loc currentBeam OPTIONAL,
      Array loc_correspond_beam_locBeam OPTIONAL
}
```

Further, the SDSM/CPM 265 or other signaling may further include information or parameters in the detected object data (e.g., for one or more detected or perceived objects), such as the following example DetetectedObjectList that may include DetectedObjectData for detected object. Such DetectedObjectData instances may include the DetMmWave parameter. This parameter or sequence, one or more other parameters or sequences, or both may indicate the information associated with the network entity 105-a, such as a quantity of beams, a location, one or more services provided by the network entity 105-a, other information associated with the network entity 105-a, or any combination thereof.

```
DetectedObjectList ::= SEQUENCE (SIZE(1.256)) OF DetectedObjectData
DetectedObjectData ::= SEQUENCE {
      detObjCommon DetectedObjectCommonData, -- Common data for detected
      object
      detVehDetectedVehicleData OPTIONAL, -- Detected vehicle data
      detVRU DetectedVRUData OPTIONAL, -- Detected VRU data
      detObst DetectedObstacleData OPTIONAL, -- Detected obstacle data
      detMmWave DetectedMmWaveData OPTIONAL, -- Detected mmWave data
      (for OBU)
.
}
```

In some examples, the detMmWave parameter or sequence may include information such as the information included in the following example detMmWave parameter or sequence.

```
DetectedMmWaveData ::= SEQUENCE {
      Array of beams beamNum OPTIONAL,
      Array_azimuth_angle_per_beam beamAzimuth OPTIONAL,
      Array_elevation_angle_per_beam beamElevation OPTIONAL,
      Current_gNB_beam currentBeam OPTIONAL,
}
```

In some examples, the first OBU 210, the network entity 105-a, the second OBU 215, or any combination thereof, may obtain map information 290 that may correspond to or be associated with the location information 280, a location of the first OBU 210, a location of the RSU 220, a location of the network entity 105-a, the second OBU 215, or any combination thereof. In some examples, the map information 290 may be independent from location information (e.g., the location information 280). The first OBU 210, the network entity 105-a, the second OBU 215, or any combination thereof, may overlay the map information 290 and the location information 280 (or other location information as described herein) and may perform a beam sweeping procedure using one or more beams (e.g., the beams 225, the beams 230, or the beams 250) that may be selected for the beam sweeping procedure based at least in part on the map information 290, the location information 280, other location information described herein, or any combination thereof. The use of the map information 290 may apply to a beam sweeping procedure between the first OBU 210 and the network entity 105-a, a beam sweeping procedure between the second OBU 215 and the network entity 105-a, or any combination thereof.

In some examples, the map information 290 may be pre-loaded, obtained over a wireless communications network, or any combination thereof. For example, a coarse or less-detailed version of the map information 290 may be pre-loaded at a device and finer map details may be downloaded over a wireless communications network (e.g., based on a location of such a device). Further, in some examples, the entirety may be map information 290 may be downloaded over a wireless communications network.

The use of such map information 290 may aid the first OBU 210, the second OBU 215, the network entity 105-a, or any combination thereof, to improve upon the location information 280 or other location information. For example, a location of the RSU 220 or the first OBU 210 may be more precisely calculated or obtained (e.g., a lane position or location may be determined more precisely). In some examples, obstacles, road trajectories, geographic features, buildings, or other environmental conditions or objects may be determined based on the map information 290 and the beam sweeping process may be adjusted accordingly (e.g., through selection of one or more beams to be used for the beam sweeping process based on the map information 290).

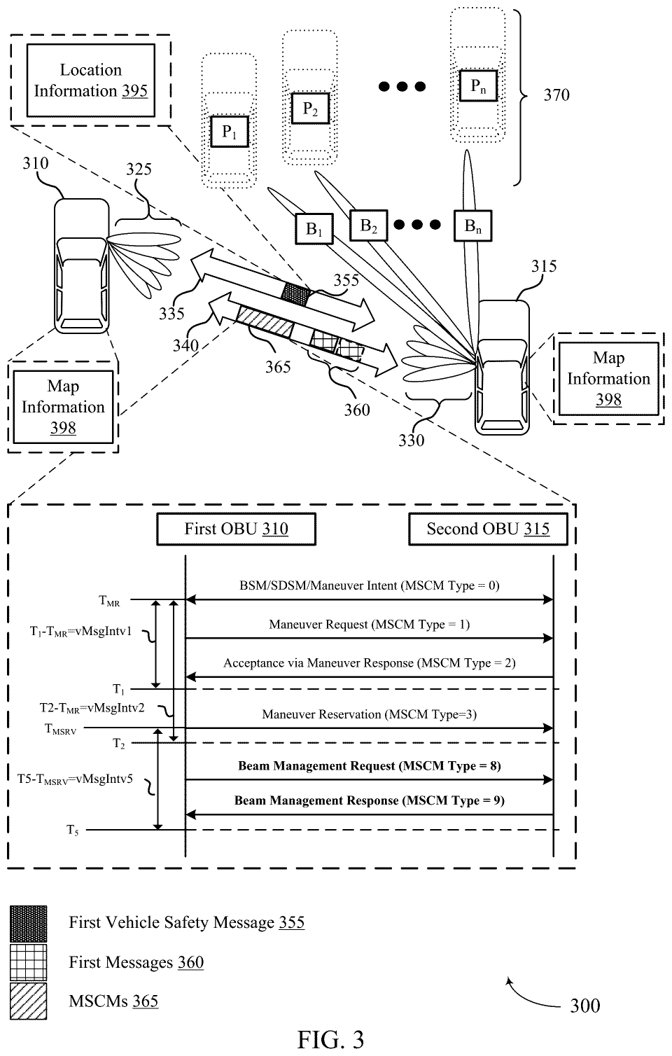

FIG. 3 shows an example of a wireless communications system 300 that supports assisted beam management in accordance with one or more aspects of the present disclosure.

Just as a beam sweeping procedures between an OBU and a network entity 105-a may be improved, so may beam sweeping procedures between multiple OBUs communicating in sidelink be improved. For example, in sidelink communications (e.g., including sidelink mmWave communications), wireless devices may predict the current and future beam indexes to be used for communications. However, determining narrow beams may involve prohibitively large beam training overhead which consumes compute resources and incurs latency cost. Further, for high mobility applications, beam prediction or management may involve additional challenges due to the channel rapidly changing and more frequently performed beam training.

Some approaches (e.g., for stationary cases) use sensing information of the environment (e.g., through camera, LiDAR, or other environmental sensing) to reduce the training overhead. For example, a wireless device may predict one or more beams using sensory input from a same or current time or may predict one or more future beams using sensory input from previous time steps. However, such approaches may be improved by utilizing location information and beam management information in SSB communications (or in other signaling) and MSCMs exchanged between OBUs to reduce the training overhead for sidelink beam prediction and tracking. For example, OBUs may communicate via a unicast session in sidelink unlicensed mmWave communications for applications such as raw sensor sharing with first antennas and hardware and may further transmit vehicle safety messages (e.g., such as BSMs) using an ITS band with second antenna or hardware.

For example, in order to set up a unicast sidelink session, the first OBU 310 and the second OBU 315 may align their beams in a beam sweeping procedure, optionally involving sidelink SSB communications or any other type of signaling that may be compatible with a beam sweeping procedure. For example, other types of sensing may be used. Though examples included herein may describe types of signaling, other types of signaling may also be used (e.g., types of RF sensing signaling) with the same or similar techniques. These techniques may also be used to set up a unicast sidelink session between OBU-RSUs. Such operations may transmit beam sweeping, but this may involve additional latency as compared to WWAN situations due to differences in periodicities. For example, in sidelink, transmit beam sweeping of 64 beams may have a duration of at least 8 ms (e.g., for an S-SSB burst). Since an S-SSB burst has a periodicity of 160 ms, assuming just 8 beams on the receiving side, the whole beam sweeping procedure may have a duration of more than 1.28 seconds. Such a latency is higher than a beam alignment latency in WWAN (e.g., where SSB bursts may have a periodicity of 20 ms). Given this increase in latency, including location information (e.g., geolocation information, relative positioning information, or other location information) in vehicle safety messages (e.g., BSMs) or other messages may aid in significant reductions in latency, overhead, and power consumption.

In some examples, OBUs may transmit such vehicle safety messages (e.g., BSMs) at different rates (e.g., 10 Hz or lower depending on congestion level). As such, the location information 395 included in the first vehicle safety message 355 may be used to adjust beams 325, beams 330, or both during initial alignment and session setup and as well as during tracking operations. In some examples, sidelink positioning information or procedure may be used to augment the accuracy of the location information 395. Such sidelink positioning information may be applicable in OBU to OBU communications or in OBU to RSU communications in which the RSU has an accurate understanding of its own true location.

For example, the second OBU 315 may transmit the first vehicle safety message 355 (e.g., which may be a BSM) to the second OBU 310 over the first channel 335 (which may be associated with an ITS band). The first vehicle safety message 355 may include the location information 395 that may be associated with the second OBU 315. Such location information 395 may indicate one or more positions of the second OBU 315, past, present, or future. The first OBU 310 and the second OBU 315 may perform a beam sweeping procedure (e.g., over the second channel 340, which may be associated with a mmWave band) to select or determine one or more beams (e.g., of the beams 325, beams 330, or both) to be used for communications (e.g., for communicating the one or more first messages 360 over the second channel 340).

In some examples, the location information 395 may be used to select or determine (or, alternatively, exclude) one or more beams from a pool of candidate beams that will be used for performing the beam sweeping procedure. For example, some beams of the beams 325, the beams 330, or both, may be oriented in a direction or towards a location corresponding with the location information 395 and may be included in the beam sweeping procedure. Other beams, however, may be excluded from the beam sweeping procedure if they are not at least partially oriented in a direction or towards a location corresponding with the location information 395.

In some examples, the first OBU 310 and the second OBU 315 may engage in a mmWave unicast session (e.g., for raw sensor sharing) as they exchange the MSCMs 365 to coordinate a maneuver 370 such as a lane change. The maneuver 370 may include one or more positions (designated by P₁, P₂, . . . Pₙ) in which the first vehicle may be located at point during the maneuver.

As part of the maneuver coordination process, the first OBU 310 and the second OBU 315 may exchange MSCMs 365 of various types (e.g., including those depicted in FIG. 3) that may be (e.g., either individually or collectively) unicast messages, groupcast messages, or broadcast messages. For example, the first OBU 310 may transmit a first MSCM 365 to the second OBU 315 that may be a maneuver request message (e.g., a Type 1 MSCM). The maneuver request message may include information such as a maneuver start and end time, min and max speed, and target road resource (TRR). Other MSCM types may include a Maneuver Intent (mSCMType=0), a Maneuver Request (mSCMType=1), a Maneuver Response (mSCMType=2), a Maneuver Reservation (mSCMType=3), an HV (e.g., leading vehicle) Maneuver Cancellation (mSCMType=4), an RV (e.g., trailing vehicle or a vehicle in any position, such as a position relative to an OBU or other wireless device associated with a vehicle or in a position next to the OBU or other wireless device associated with a vehicle) Maneuver Cancellation Request (mSCMType=5), Emergency Maneuver Reservation (mSCMType=6), and Maneuver Execution Status (mSCMType=7).

However, in some examples, the maneuver coordination process using MSCMs 365 may be improved by including additional types of MSCMs 365 that may include a beam management request (MSCM Type=8), a beam management response (MSCM Type=9), or both.

For example, the first OBU 310 may transmit a beam management request MSCM (e.g., a Type 8 MSCM) to initiate a beam management session with one or more particular OBUs or vehicles (e.g., the second OBU 315 associated with the second vehicle) determined by one or more destinationIDs that may be included in the beam management request MSCM. The beam management request MSCM may also include additional information about the maneuver to be performed that may not have been included in the maneuver request, such as such as midway positions P₁ and P₂ with corresponding time instances). In some examples, a data field may be included in the maneuver request message to indicate OBUs or vehicles to which beam management is to be performed.

The second OBU 315 may use the information about the first OBU's 310 maneuver into account and calculate relevant beams (e.g., beams B₁, B₂, . . . Bₙ) during its maneuver course until landing at the TRR. The second OBU 315 may transmit a beam management response MSCM (e.g., a Type 9 MSCM) to the first OBU 310 that may include the relevant calculated beams to be used during the maneuver. The beam management response MSCM may indicate a correlation between the positions (e.g., P₁, P₂, . . . Pₙ) and the beams (B₁, B₂, . . . Bₙ) and may be a unicast, groupcast, or broadcast message. In some examples, angular coverage of each beam (e.g., in azimuth and elevation) may also be conveyed in the beam management response MSCM.

In some examples, the first OBU 310, the second OBU 315, or any combination thereof, may obtain map information 398 that may correspond to or be associated with the location information 395, a location of the first OBU 310, the second OBU 315, or any combination thereof. In some examples, the map information 398 may be independent from location information (e.g., the location information 395). The first OBU 310, the second OBU 315, or any combination thereof, may overlay the map information 398 and the location information 395 (or other location information as described herein) and may perform a beam sweeping procedure using one or more beams (e.g., the beams 225, the beams 230, or the beams 250) that may be selected for the beam sweeping procedure based at least in part on the map information 398, the location information 395, other location information described herein, or any combination thereof. The use of the map information 398 may apply to a beam sweeping procedure between the first OBU 310 and the network entity 105-a, a beam sweeping procedure between the second OBU 315 and the network entity 105-a, or any combination thereof.

In some examples, the map information 398 may be pre-loaded, obtained over a wireless communications network, or any combination thereof. For example, a coarse or less-detailed version of the map information 398 may be pre-loaded at a device and finer map details may be downloaded over a wireless communications network (e.g., based on a location of such a device). Further, in some examples, the entirety may be map information 398 may be downloaded over a wireless communications network.

The use of such map information 398 may aid the first OBU 310, the second OBU 315, the network entity 105-a, or any combination thereof, to improve upon the location information 395 or other location information. For example, a location of the first OBU 310 or the second OBU 315 may be more precisely calculated or obtained (e.g., a lane position or location may be determined more precisely). In some examples, obstacles, road trajectories, geographic features, buildings, or other environmental conditions or objects may be determined based on the map information 398 and the beam sweeping process may be adjusted accordingly (e.g., through selection of one or more beams to be used for the beam sweeping process based on the map information 398).

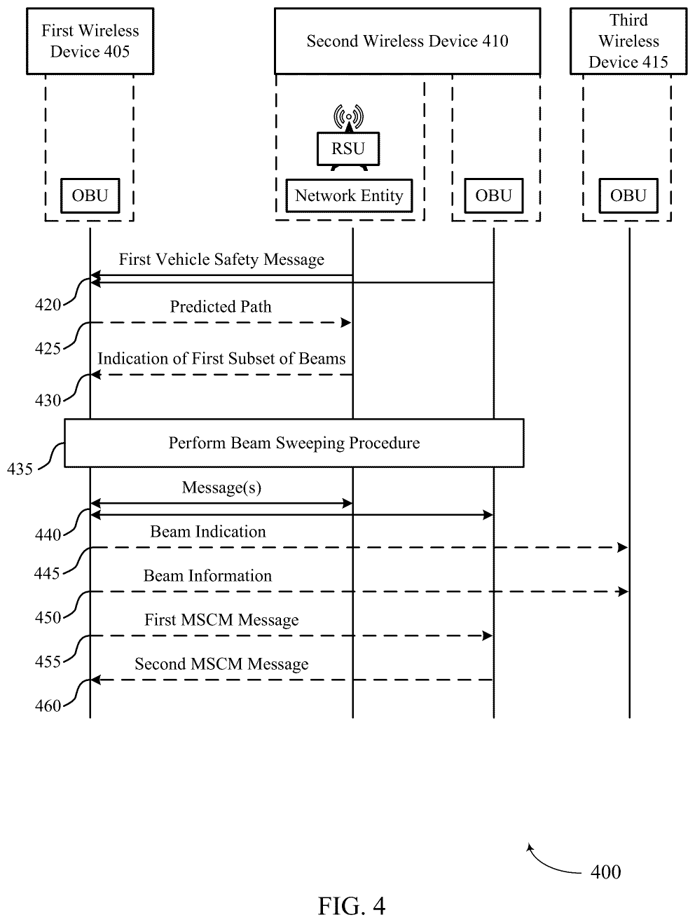

FIG. 4 shows an example of a process flow 400 that supports assisted beam management in accordance with one or more aspects of the present disclosure.

The process flow 400 may implement various aspects of the present disclosure described herein. The elements described in the process flow 400 (e.g., the first wireless device 405, the second wireless device 410, and the third wireless device 415) may be examples of similarly-named elements described herein.

In some examples described herein, the second wireless device 410 may be an RSU, a network entity, a network entity co-located with an RSU, an OBU, or another wireless device. In some cases, different operations described in the process flow 400 may apply to different examples of the second wireless device 410. For example, as shown in the process flow 400, an example of a second wireless device 410 that is a network entity co-located with an RSU is depicted alongside another example of a second wireless device 410 that is an OBU. In some examples, one or more operations in the process flow 400 may apply to or may be associated with the example of the network entity co-located with the RSU, the example of the OBU, or both. Though some elements and operations are shown as examples, other combinations of elements, operations, or other subject matter disclosed herein are also possible.

In the following description of the process flow 400, the operations between the various entities or elements may be performed in different orders or at different times. Some operations may also be left out of the process flow 400, or other operations may be added. Although the various entities or elements are shown performing the operations of the process flow 400, some aspects of some operations may also be performed by other entities or elements of the process flow 400 or by entities or elements that are not depicted in the process flow, or any combination thereof.

At 420, the first wireless device 405 may receive, over a first frequency band, a first vehicle safety message that may indicate location information of a second wireless device 410. In some examples, the first wireless device is an on-board unit (OBU) and the second wireless device 410 is a network entity co-located with a road-side unit (RSU). In some examples, the first wireless device is a first on-board unit (OBU) and the second wireless device 410 is a second OBU. In some examples, the first frequency band is an intelligent transportation system (ITS) band.

At 425, the first wireless device 405 may transmit, to the second wireless device 410, a predicted path on which the first wireless device is to travel. In some examples, the first subset of beams corresponds to the predicted path and the location information.

At 430, the first wireless device 405 may receive, from the second wireless device 410, an indication of the first subset of beams.

At 435, the first wireless device 405 may perform, with the second wireless device 410 over a second frequency band that differs from the first frequency band, a beam sweeping procedure using a first subset of beams from a plurality of available beams to determine one or more beams of the first subset of beams to be used for communication with the second wireless device 410, each beam of the first subset of beams being oriented at least partially in a direction corresponding to the location information of the second wireless device 410. In some examples, the beam sweeping procedure may be performed over an access link, a PC5 link, one or more other communication links, or any combination thereof. In some examples, the second frequency band is a millimeter wave band.

At 440, the first wireless device 405 may communicate, over the second frequency band, one or more messages with the second wireless device 410 using the one or more beams of the first subset of beams. In some examples, the first wireless device 405 may communicate over the second frequency band with the second wireless device 410 using the one or more beams of the first subset of beams in a sidelink unicast session.

At 445, the first wireless device 405 may transmit, to a third wireless device 415 associated with a second vehicle, an indication of the one or more beams of the first subset of beams and the first subset of beams corresponds to a location of the first wireless device and the location information and wherein the first subset of beams is identified based on the location of the first wireless device and the location information. In some examples, the first wireless device 405 may transmit the indication of the one or more beams of the first subset of beams via a sensor data sharing message or a collective perception message.

At 450, the first wireless device 405 may transmit, to the third wireless device 415, an indication of a quantity of beams of the one or more beams of the first subset of beams, an indication of one or more beam azimuths associated with the one or more beams of the first subset of beams, an indication of one or more beam elevations associated with the one or more beams of the first subset of beams, an indication of one or more services provided by the second wireless device 410, or any combination thereof.

At 455, the first wireless device 405 may transmit, to the second wireless device 410, a first maneuver sharing and coordination message (MSCM) that may include a beam management session request and maneuver information associated with a maneuver to be performed by a vehicle associated with the first wireless device. In some examples, the first MSCM may indicate one or more wireless devices associated with corresponding vehicles that are requested to participate in the beam sweeping procedure.

At 460, the first wireless device 405 may receive, from the second wireless device 410, a second MSCM that may include an indication of the first subset of beams, the first subset of beams oriented at least partially towards one or more locations associated with the maneuver.

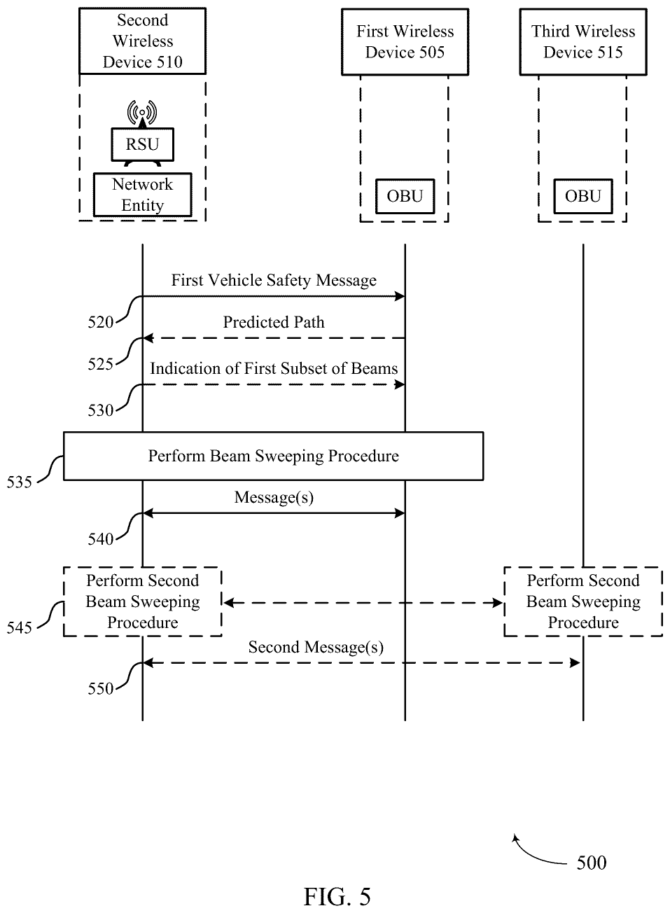

FIG. 5 shows an example of a process flow 500 that supports assisted beam management in accordance with one or more aspects of the present disclosure.

The process flow 500 may implement various aspects of the present disclosure described herein. The elements described in the process flow 500 (e.g., the first wireless device 505 505, the second wireless device 510, and the third wireless device 515) may be examples of similarly-named elements described herein.

In the following description of the process flow 500, the operations between the various entities or elements may be performed in different orders or at different times. Some operations may also be left out of the process flow 500, or other operations may be added. Although the various entities or elements are shown performing the operations of the process flow 500, some aspects of some operations may also be performed by other entities or elements of the process flow 500 or by entities or elements that are not depicted in the process flow, or any combination thereof.

At 520, the second wireless device 510 may transmit, over a first frequency band, a first vehicle safety message that may indicate location information of the second wireless device. In some examples, the first wireless device 505 is an on-board unit (OBU) and the second wireless device is a network entity co-located with a road-side unit (RSU). In some examples, the first frequency band is an intelligent transportation system (ITS) band. In some examples, the second frequency band is a millimeter wave band.

At 525, the second wireless device 510 may receive, from the first wireless device 505, a predicted path on which the first wireless device 505 is to travel and the first subset of beams may correspond to the predicted path and the location information.

At 530, the second wireless device 510 may transmit, to the first wireless device 505, an indication of the first subset of beams.

At 535, the second wireless device 510 may perform, with a first wireless device 505 over a second frequency band that differs from the first frequency band, a beam sweeping procedure using a first subset of beams from a plurality of available beams to determine one or more beams of the first subset of beams to be used for communication with the first wireless device 505, each beam of the first subset of beams being oriented at least partially in a direction corresponding to the location information of the second wireless device.

At 540, the second wireless device 510 may communicate, over the second frequency band, one or more messages with the first wireless device 505 using the one or more beams of the first subset of beams.

At 545, the second wireless device 510 may perform, with a third wireless device 515 over the second frequency band and based on the one or more beams of the first subset of beams, a second beam sweeping procedure to determine one or more second beams of the first subset of beams to be used for communication with the third wireless device 515 and a location of the third wireless device 515 corresponds to the location information of the second wireless device.

At 550, the second wireless device 510 may communicate, over the second frequency band, one or more second messages with the third wireless device 515 using the one or more second beams.

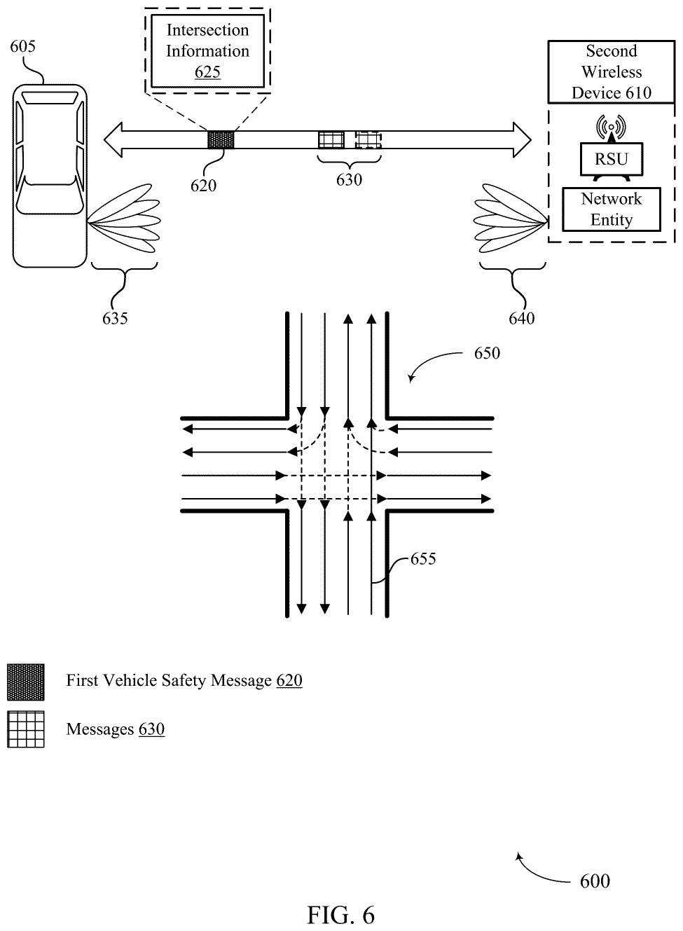

FIG. 6 shows an example of a wireless communications system 600 that supports assisted beam management in accordance with one or more aspects of the present disclosure.

In some examples, the first wireless device 605 (e.g., an OBU) may communicate with the second wireless device 610. The second wireless device 610 may include an RSU, a network entity, or both. In some examples, the second wireless device 610 may include an RSU and a network entity that are co-located. The first wireless device 605 may be associated with a vehicle that may be traveling near an intersection 650, which may include one or more lanes 655.

In some examples, the first wireless device 605 may receive the first vehicle safety message 620 from the second wireless device 610. In some examples, the first vehicle safety message 620 may be a signal phase and timing (SPaT) message, a TSPaT message, a map data (MAP) message, or a road geometry attributes message. The first vehicle safety message 620 may include intersection information 625 associated with the intersection 650. The intersection information 625 may include information associated with the beams 635, the beams 640, or both, that may be used for a beam sweeping procedure between the first wireless device 605 and the second wireless device 610.

For example, the intersection information 625 may include information associated with the intersection, including an intersection identifier, a reference point, one or more indications of the lanes 655, one or more connections associated with one or more lanes 655, one or more signal groups (e.g., that include or are associated with one or more connections), or any combination thereof. Such information may be included in a MAP message such as the following example MAP message:

```
MAP
      Intersection Geometry 1
            Intersection ID, Reference Point
            Lane 1
                  Node Points
            Lane 2
            Lane 3
            ..
      Lane N
            Attributes (e.g., type, in/out)
            Connection 1
            Connection 2
            . . .
            Connection N
```

Additionally, or alternatively, the intersection information 625 may include an intersection state for the intersection 650, an intersection identifier associated with the intersection 650, one or more indications of one or more signal groups, a current phase for a signal group, an end time for a current phase for a signal group, one or more upcoming phases for a signal group, or any combination thereof. Such information may be expressed as shown in the following example of a SPAT message:

```
SPaT
      Intersection State 1
            Intersection ID
            Signal Group 1
                  Current Phase
                        Phase (e.g., green/yellow/red)
                        End Time
                  Next Phase 1
                  . . .
                  Next Phase N
            Signal Group 2
            Signal Group 3
            . . .
      Signal Group N
```

Additionally, or alternatively, the intersection information 625 may include a public land mobile network (PLMN) identifier, beam azimuth information, beam elevation information, current beam information (e.g., a beam used at the second wireless device 610), or any combination thereof. Such information may be associated with an intersection geometry portion of a MAP message, one or more connection portions of a MAP message, or any combination thereof. Additionally, or alternatively, such information may be associated with a signal group indicated or included in a SPaT message. Further, such information may be expressed as in the following examples of mmWave data elements:

```
MmWaveData ::= SEQUENCE {
PLMN_ID1
      Array of beams beamNum OPTIONAL,
      Array_azimuth_angle_per_beam beam Azimuth OPTIONAL,
      Array_elevation_angle_per_beam beamElevation OPTIONAL,
}
MmWaveData ::= SEQUENCE {
PLMN_ID1
      current_gNB_beam_for_connecting_lane  currentBeam OPTIONAL
}
```

In some examples, the intersection information 625 may be static, semi-static, or dynamic. For example, in some situations or intersections 650, a direction of traffic or other characteristic of the intersection may be different at different times of day or based on other factors. In some examples, the second wireless device 610 (e.g., the network entity of the second wireless device 610) may include a capability for antenna steering, which may be used to adjust an amount of wireless coverage or bandwidth to one or more lanes 655 of the intersection 650. In some examples, beam widths of the beams 635, the beams 640, or both, may be adjusted based on different traffic conditions.

Thus, the second wireless device 610 may indicate one or more beams, beam direction information, beam exclusion information, or any combination thereof to the first wireless device 605 and other wireless devices. Such information may be applicable to one or more lanes 655 of the intersection. For example, first beam information may be applicable for devices associated with a first set of lanes (e.g., of the lanes 655) whereas second beam information (e.g., different than the first beam information) may be applicable to devices associated with a second set of lanes (e.g., of the lanes 655). A set of lanes may include one or more ingress lanes, one or more egress lanes, or any combination thereof.

After or in response to performing the beam sweeping procedure, the first wireless device 605 and the second wireless device 610 may communicate one or more messages 630 using one or more beams determined or selected though the beam sweeping procedure.

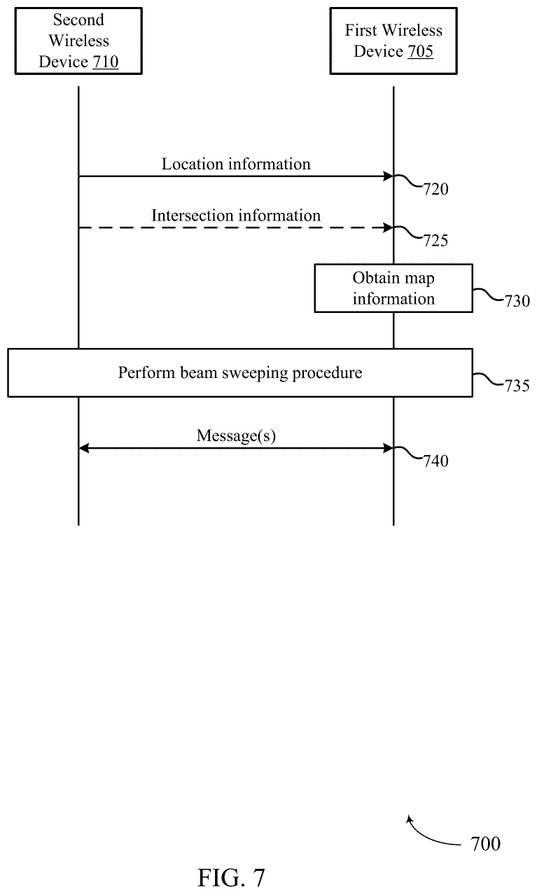

FIG. 7 shows an example of a process flow 700 that supports assisted beam management in accordance with one or more aspects of the present disclosure.

The process flow 700 may implement various aspects of the present disclosure described herein. The elements described in the process flow 700 (e.g., the first wireless device 705 and the second wireless device 710) may be examples of similarly named elements described herein.

In the following description of the process flow 700, the operations between the various entities or elements may be performed in different orders or at different times. Some operations may also be left out of the process flow 700, or other operations may be added. Although the various entities or elements are shown performing the operations of the process flow 700, some aspects of some operations may also be performed by other entities or elements of the process flow 700 or by entities or elements that are not depicted in the process flow, or any combination thereof.

At 720, the first wireless device 705 may receive, over a first frequency band, a first vehicle safety message indicating location information of a second wireless device. In some examples, the first wireless device is an on-board unit (OBU) and the second wireless device 710 is a network entity co-located with a road-side unit. In some examples, the first wireless device is a first on-board unit (OBU) associated with a first vehicle and the second wireless device 710 is a second OBU associated with a second vehicle. In some examples, the first frequency band is an intelligent transportation system (ITS) band.

At 725, the first wireless device 705 may receive, over the first frequency band from the second wireless device, a first message that may include intersection information associated with an intersection that may include a plurality of lanes and the intersection information may include beam direction information associated with a subset of the plurality of lanes.

At 730, the first wireless device 705 may obtain map information corresponding to a geographic area associated with the location information. In some examples, the first wireless device 705 may receive the map information from the second wireless device.

At 735, the first wireless device 705 may perform, with the second wireless device 710 over a second frequency band that differs from the first frequency band, a beam sweeping procedure using a first subset of beams from a plurality of available beams to determine, based on the location information and the map information, one or more beams of the first subset of beams to be used for communication with the second wireless device. In some examples, performing the beam sweeping procedure is based on the intersection information. In some examples, the second frequency band is a millimeter wave band.

At 740, the first wireless device 705 may communicate, over the second frequency band, one or more messages with the second wireless device 710 using the one or more beams of the first subset of beams.

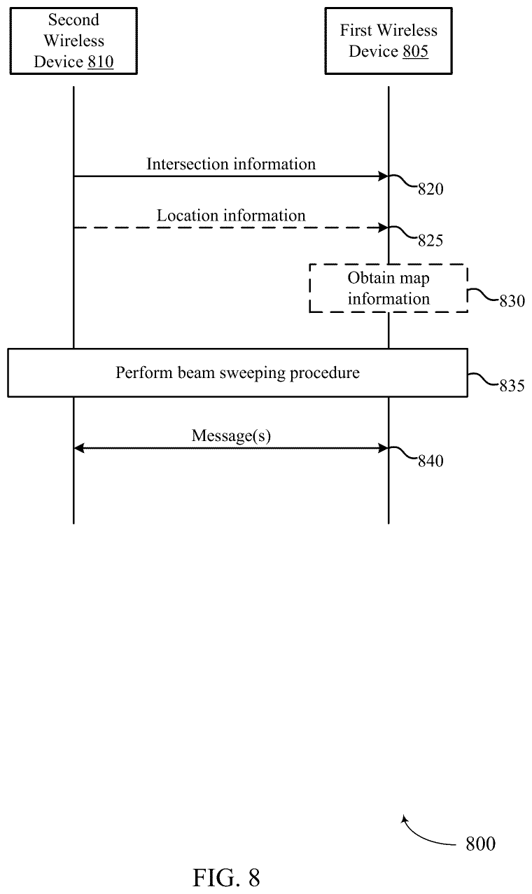

FIG. 8 shows an example of a process flow 800 that supports assisted beam management in accordance with one or more aspects of the present disclosure.

The process flow 800 may implement various aspects of the present disclosure described herein. The elements described in the process flow 800 (e.g., the first wireless device 805 and the second wireless device 810) may be examples of similarly named elements described herein.

In the following description of the process flow 800, the operations between the various entities or elements may be performed in different orders or at different times. Some operations may also be left out of the process flow 800, or other operations may be added. Although the various entities or elements are shown performing the operations of the process flow 800, some aspects of some operations may also be performed by other entities or elements of the process flow 800 or by entities or elements that are not depicted in the process flow, or any combination thereof.

At 820, the first wireless device 805 may receive, over a first frequency band, a first vehicle safety message that may include intersection information associated with an intersection that may include a plurality of lanes and the intersection information may include beam direction information associated with a subset of the plurality of lanes. In some examples, the first vehicle safety message is a signal phase and time message, a map data message, or a road geometry attributes message. In some examples, the first vehicle safety message may include a beam quantity parameter indicating a plurality of beams, a beam azimuth angle parameter for each beam of the plurality of beams, a beam elevation parameter for each beam of the plurality of beams, a current beam parameter for the subset of the plurality of lanes, or any combination thereof. In some examples, the current beam parameter is associated with a lane connection parameter that is associated with the subset of the plurality of lanes. In some examples,

the first vehicle safety message may include a plurality of identifiers associated with the plurality of available beams. In some examples, the first wireless device is an on-board unit (OBU) and the second wireless device 810 is a network entity co-located with a road-side unit. In some examples, the first vehicle safety message indicates a public land mobile network (PLMN) identifier associated with the second wireless device. In some examples, the first frequency band is an intelligent transportation system (ITS) band.

At 825, the first wireless device 805 may receive, over the first frequency band, a second vehicle safety message indicating location information of the second wireless device.

At 830, the first wireless device 805 may obtain map information corresponding to a geographic area associated with the location information.

At 835, the first wireless device 805 may perform, with a second wireless device 810 over a second frequency band that differs from the first frequency band, a beam sweeping procedure using a first subset of beams from a plurality of available beams to determine, based on the intersection information, one or more beams of the first subset of beams to be used for communication with the second wireless device. In some examples, performing the beam sweeping procedure is based on the location information and the map information. In some examples, the first wireless device 805 may perform the beam sweeping procedure based on the subset of the plurality of lanes corresponding to a first vehicle associated with the first wireless device and the subset of the plurality of lanes corresponds to the first subset of beams. In some examples, performing the beam sweeping procedure is based on the current beam parameter. In some examples,

the one or more beams of the first subset of beams are determined based on corresponding identifiers of the plurality of identifiers. In some examples, the second frequency band is a millimeter wave band.

At 840, the first wireless device 805 may communicate, over the second frequency band, one or more messages with the second wireless device 810 using the one or more beams of the first subset of beams.

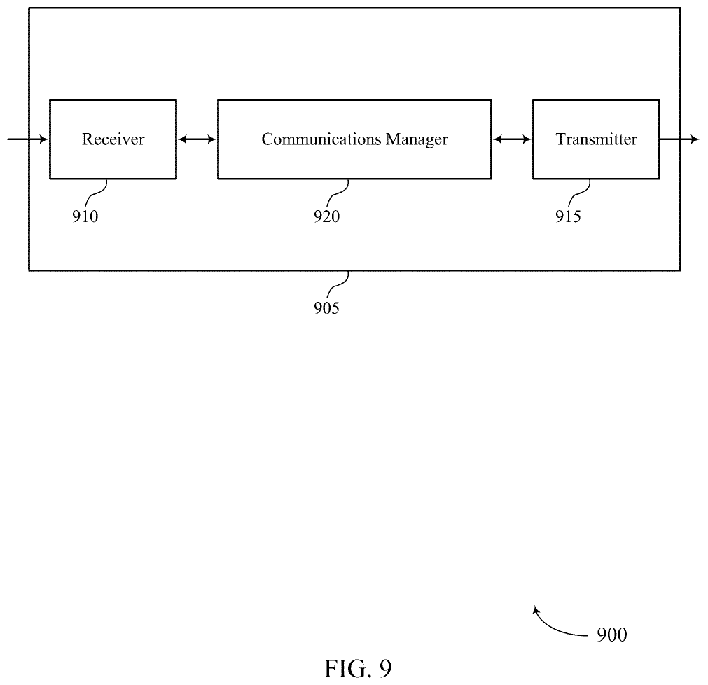

FIG. 9 shows a block diagram 900 of a device 905 that supports assisted beam management in accordance with one or more aspects of the present disclosure. The device 905 may be an example of aspects of a UE 115 as described herein. The device 905 may include a receiver 910, a transmitter 915, and a communications manager 920. The device 905, or one or more components of the device 905 (e.g., the receiver 910, the transmitter 915, and the communications manager 920), may include at least one processor, which may be coupled with at least one memory, to, individually or collectively, support or enable the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to assisted beam management). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to assisted beam management). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of assisted beam management as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor. If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

Additionally, or alternatively, the communications manager 920 may support wireless communications in accordance with examples as disclosed herein. For example, the communications manager 920 is capable of, configured to, or operable to support a means for receiving, over a first frequency band, a first vehicle safety message indicating location information of a second wireless device. The communications manager 920 is capable of, configured to, or operable to support a means for obtaining map information corresponding to a geographic area associated with the location information. The communications manager 920 is capable of, configured to, or operable to support a means for performing, with the second wireless device over a second frequency band that differs from the first frequency band, a beam sweeping procedure using a first subset of beams from a set of multiple available beams to determine, based on the location information and the map information, one or more beams of the first subset of beams to be used for communication with the second wireless device. The communications manager 920 is capable of, configured to, or operable to support a means for communicating, over the second frequency band, one or more messages with the second wireless device using the one or more beams of the first subset of beams.

Additionally, or alternatively, the communications manager 920 may support wireless communications in accordance with examples as disclosed herein. For example, the communications manager 920 is capable of, configured to, or operable to support a means for receiving, over a first frequency band, a first vehicle safety message including intersection information associated with an intersection including a set of multiple lanes, where the intersection information includes beam direction information associated with a subset of the set of multiple lanes. The communications manager 920 is capable of, configured to, or operable to support a means for performing, with a second wireless device over a second frequency band that differs from the first frequency band, a beam sweeping procedure using a first subset of beams from a set of multiple available beams to determine, based on the intersection information, one or more beams of the first subset of beams to be used for communication with the second wireless device. The communications manager 920 is capable of, configured to, or operable to support a means for communicating, over the second frequency band, one or more messages with the second wireless device using the one or more beams of the first subset of beams.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for reduced processing, reduced power consumption, more efficient utilization of communication resources, or any combination thereof.

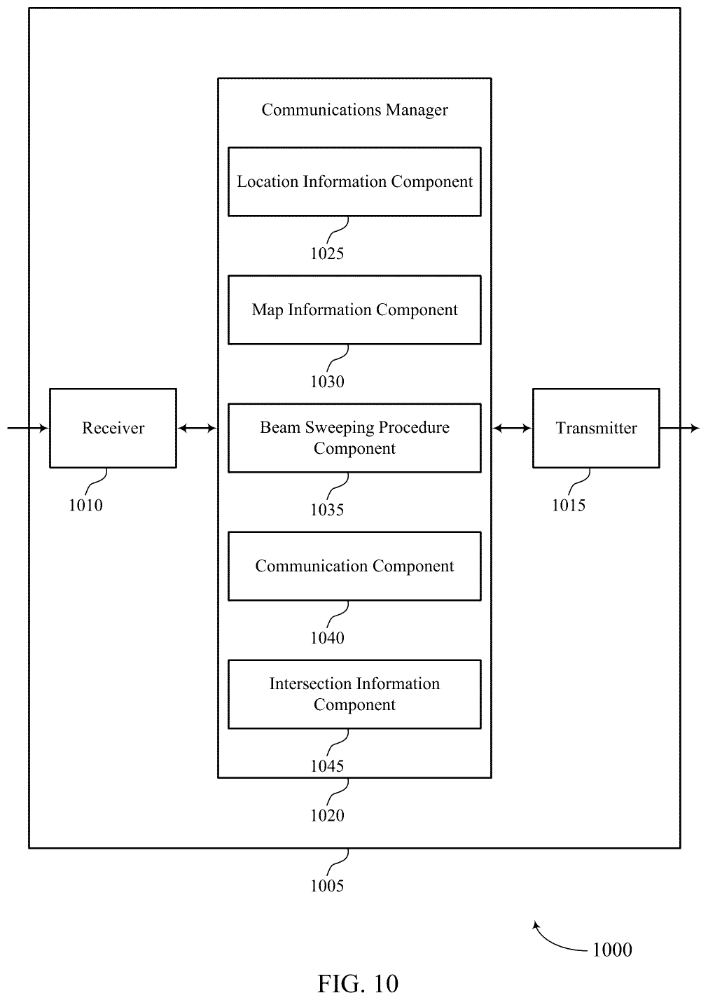

FIG. 10 shows a block diagram 1000 of a device 1005 that supports assisted beam management in accordance with one or more aspects of the present disclosure. The device 1005 may be an example of aspects of a device 905 or a UE 115 as described herein. The device 1005 may include a receiver 1010, a transmitter 1015, and a communications manager 1020. The device 1005, or one or more components of the device 1005 (e.g., the receiver 1010, the transmitter 1015, and the communications manager 1020), may include at least one processor, which may be coupled with at least one memory, to support the described techniques. Each of these components may be in communication with one another (e.g., via one or more buses).

The receiver 1010 may provide a means for receiving information such as packets, user data, control information, or any combination thereof associated with various information channels (e.g., control channels, data channels, information channels related to assisted beam management). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to assisted beam management). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of assisted beam management as described herein. For example, the communications manager 1020 may include a location information component 1025, a map information component 1030, a beam sweeping procedure component 1035, a communication component 1040, an intersection information component 1045, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The location information component 1025 is capable of, configured to, or operable to support a means for receiving, over a first frequency band, a first vehicle safety message indicating location information of a second wireless device. The map information component 1030 is capable of, configured to, or operable to support a means for obtaining map information corresponding to a geographic area associated with the location information. The beam sweeping procedure component 1035 is capable of, configured to, or operable to support a means for performing, with the second wireless device over a second frequency band that differs from the first frequency band, a beam sweeping procedure using a first subset of beams from a set of multiple available beams to determine, based on the location information and the map information, one or more beams of the first subset of beams to be used for communication with the second wireless device. The communication component 1040 is capable of, configured to, or operable to support a means for communicating, over the second frequency band, one or more messages with the second wireless device using the one or more beams of the first subset of beams.

Additionally, or alternatively, the communications manager 1020 may support wireless communications in accordance with examples as disclosed herein. The intersection information component 1045 is capable of, configured to, or operable to support a means for receiving, over a first frequency band, a first vehicle safety message including intersection information associated with an intersection including a set of multiple lanes, where the intersection information includes beam direction information associated with a subset of the set of multiple lanes. The beam sweeping procedure component 1035 is capable of, configured to, or operable to support a means for performing, with a second wireless device over a second frequency band that differs from the first frequency band, a beam sweeping procedure using a first subset of beams from a set of multiple available beams to determine, based on the intersection information, one or more beams of the first subset of beams to be used for communication with the second wireless device. The communication component 1040 is capable of, configured to, or operable to support a means for communicating, over the second frequency band, one or more messages with the second wireless device using the one or more beams of the first subset of beams.

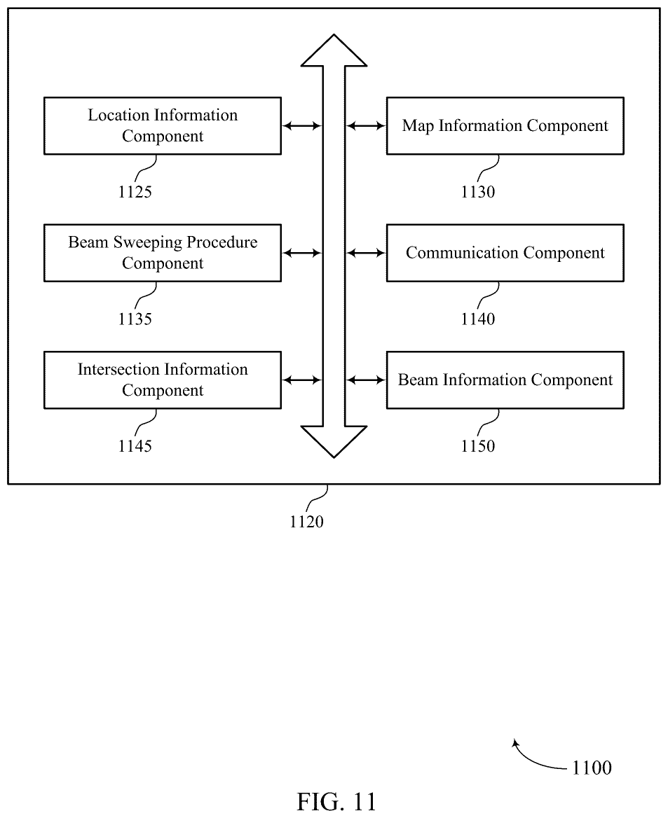

FIG. 11 shows a block diagram 1100 of a communications manager 1120 that supports assisted beam management in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of assisted beam management as described herein. For example, the communications manager 1120 may include a location information component 1125, a map information component 1130, a beam sweeping procedure component 1135, a communication component 1140, an intersection information component 1145, a beam information component 1150, or any combination thereof. Each of these components, or components or subcomponents thereof (e.g., one or more processors, one or more memories), may communicate, directly or indirectly, with one another (e.g., via one or more buses).

Additionally, or alternatively, the communications manager 1120 may support wireless communications in accordance with examples as disclosed herein. The location information component 1125 is capable of, configured to, or operable to support a means for receiving, over a first frequency band, a first vehicle safety message indicating location information of a second wireless device. The map information component 1130 is capable of, configured to, or operable to support a means for obtaining map information corresponding to a geographic area associated with the location information. The beam sweeping procedure component 1135 is capable of, configured to, or operable to support a means for performing, with the second wireless device over a second frequency band that differs from the first frequency band, a beam sweeping procedure using a first subset of beams from a set of multiple available beams to determine, based on the location information and the map information, one or more beams of the first subset of beams to be used for communication with the second wireless device. The communication component 1140 is capable of, configured to, or operable to support a means for communicating, over the second frequency band, one or more messages with the second wireless device using the one or more beams of the first subset of beams.

In some examples, the intersection information component 1145 is capable of, configured to, or operable to support a means for receiving, over the first frequency band from the second wireless device, a first message including intersection information associated with an intersection including a set of multiple lanes, where the intersection information includes beam direction information associated with a subset of the set of multiple lanes. In some examples, the beam sweeping procedure component 1135 is capable of, configured to, or operable to support a means for where performing the beam sweeping procedure is based on the intersection information.

In some examples, the map information component 1130 is capable of, configured to, or operable to support a means for receiving the map information from the second wireless device.

In some examples, the first wireless device is an on-board unit (OBU) and the second wireless device is a network entity co-located with a road-side unit.

In some examples, the first wireless device is a first on-board unit (OBU) associated with a first vehicle and the second wireless device is a second OBU associated with a second vehicle.

In some examples, the first frequency band is an intelligent transportation system (ITS) band.

In some examples, the second frequency band is a millimeter wave band.

Additionally, or alternatively, the communications manager 1120 may support wireless communications in accordance with examples as disclosed herein. The intersection information component 1145 is capable of, configured to, or operable to support a means for receiving, over a first frequency band, a first vehicle safety message including intersection information associated with an intersection including a set of multiple lanes, where the intersection information includes beam direction information associated with a subset of the set of multiple lanes. In some examples, the beam sweeping procedure component 1135 is capable of, configured to, or operable to support a means for performing, with a second wireless device over a second frequency band that differs from the first frequency band, a beam sweeping procedure using a first subset of beams from a set of multiple available beams to determine, based on the intersection information, one or more beams of the first subset of beams to be used for communication with the second wireless device. In some examples, the communication component 1140 is capable of, configured to, or operable to support a means for communicating, over the second frequency band, one or more messages with the second wireless device using the one or more beams of the first subset of beams.

In some examples, the location information component 1125 is capable of, configured to, or operable to support a means for receiving, over the first frequency band, a second vehicle safety message indicating location information of the second wireless device. In some examples, the map information component 1130 is capable of, configured to, or operable to support a means for obtaining map information corresponding to a geographic area associated with the location information. In some examples, the beam sweeping procedure component 1135 is capable of, configured to, or operable to support a means for where performing the beam sweeping procedure is based on the location information and the map information.

In some examples, the first vehicle safety message is a signal phase and time message, a map data message, or a road geometry attributes message.

In some examples, the first vehicle safety message includes a beam quantity parameter indicating a set of multiple beams, a beam azimuth angle parameter for each beam of the set of multiple beams, a beam elevation parameter for each beam of the set of multiple beams, a current beam parameter for the subset of the set of multiple lanes, or any combination thereof.

In some examples, the current beam parameter is associated with a lane connection parameter that is associated with the subset of the set of multiple lanes, where performing the beam sweeping procedure is based on the current beam parameter.

In some examples, the beam sweeping procedure component 1135 is capable of, configured to, or operable to support a means for performing the beam sweeping procedure based on the subset of the set of multiple lanes corresponding to a first vehicle associated with the first wireless device, where the subset of the set of multiple lanes corresponds to the first subset of beams.

In some examples, the first vehicle safety message includes a set of multiple identifiers associated with the set of multiple available beams. In some examples, the one or more beams of the first subset of beams are determined based on corresponding identifiers of the set of multiple identifiers.

In some examples, the first wireless device is an on-board unit (OBU) and the second wireless device is a network entity co-located with a road-side unit.

In some examples, the first vehicle safety message indicates a public land mobile network (PLMN) identifier associated with the second wireless device.

In some examples, the first frequency band is an intelligent transportation system (ITS) band.

In some examples, the second frequency band is a millimeter wave band.

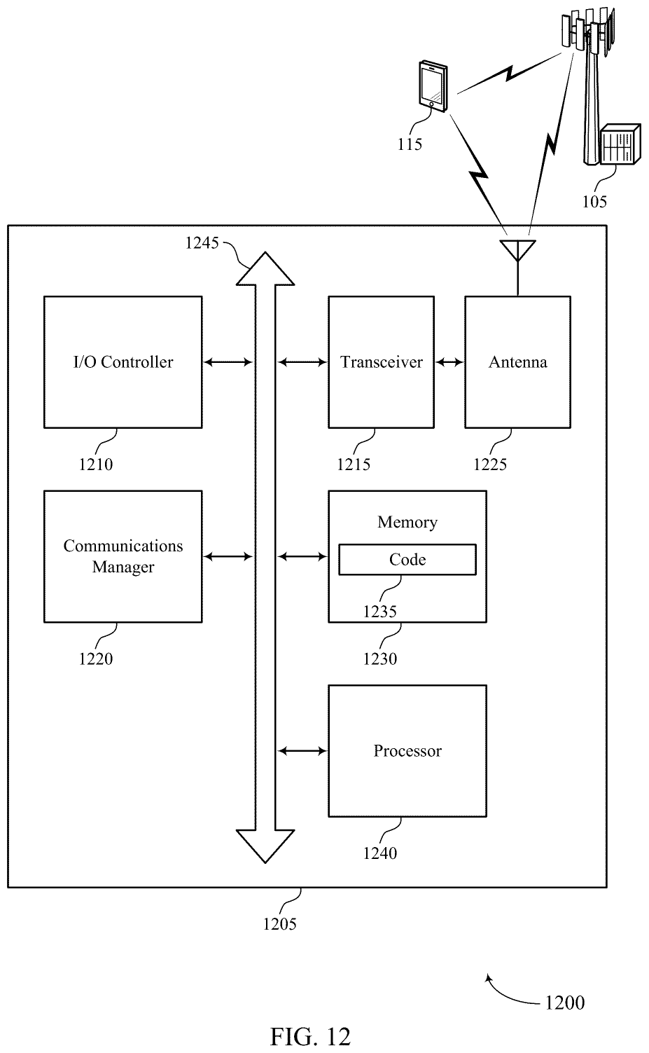

FIG. 12 shows a diagram of a system 1200 including a device 1205 that supports assisted beam management in accordance with one or more aspects of the present disclosure. The device 1205 may be an example of or include the components of a device 905, a device 1005, or a UE 115 as described herein. The device 1205 may communicate (e.g., wirelessly) with one or more network entities 105, one or more UEs 115, or any combination thereof. The device 1205 may include components for bi-directional voice and data communications including components for transmitting and receiving communications, such as a communications manager 1220, an input/output (I/O) controller 1210, a transceiver 1215, an antenna 1225, at least one memory 1230, code 1235, and at least one processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of one or more processors, such as the at least one processor 1240. In some cases, a user may interact with the device 1205 via the I/O controller 1210 or via hardware components controlled by the I/O controller 1210.

In some cases, the device 1205 may include a single antenna 1225. However, in some other cases, the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The at least one memory 1230 may include random access memory (RAM) and read-only memory (ROM). The at least one memory 1230 may store computer-readable, computer-executable code 1235 including instructions that, when executed by the at least one processor 1240, cause the device 1205 to perform various functions described herein. The code 1235 may be stored in a non-transitory computer-readable medium such as system memory or another type of memory. In some cases, the code 1235 may not be directly executable by the at least one processor 1240 but may cause a computer (e.g., when compiled and executed) to perform functions described herein. In some cases, the at least one memory 1230 may contain, among other things, a basic I/O system (BIOS) which may control basic hardware or software operation such as the interaction with peripheral components or devices.

The at least one processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 1240 may be configured to operate a memory array using a memory controller. In some other cases, a memory controller may be integrated into the at least one processor 1240. The at least one processor 1240 may be configured to execute computer-readable instructions stored in a memory (e.g., the at least one memory 1230) to cause the device 1205 to perform various functions (e.g., functions or tasks supporting assisted beam management). For example, the device 1205 or a component of the device 1205 may include at least one processor 1240 and at least one memory 1230 coupled with or to the at least one processor 1240, the at least one processor 1240 and at least one memory 1230 configured to perform various functions described herein. In some examples, the at least one processor 1240 may include multiple processors and the at least one memory 1230 may include multiple memories. One or more of the multiple processors may be coupled with one or more of the multiple memories, which may, individually or collectively, be configured to perform various functions herein. In some examples, the at least one processor 1240 may be a component of a processing system, which may refer to a system (such as a series) of machines, circuitry (including, for example, one or both of processor circuitry (which may include the at least one processor 1240) and memory circuitry (which may include the at least one memory 1230)), or components, that receives or obtains inputs and processes the inputs to produce, generate, or obtain a set of outputs. The processing system may be configured to perform one or more of the functions described herein. For example, the at least one processor 1240 or a processing system including the at least one processor 1240 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1230 or otherwise, to perform one or more of the functions described herein.

Additionally, or alternatively, the communications manager 1220 may support wireless communications in accordance with examples as disclosed herein. For example, the communications manager 1220 is capable of, configured to, or operable to support a means for receiving, over a first frequency band, a first vehicle safety message indicating location information of a second wireless device. The communications manager 1220 is capable of, configured to, or operable to support a means for obtaining map information corresponding to a geographic area associated with the location information. The communications manager 1220 is capable of, configured to, or operable to support a means for performing, with the second wireless device over a second frequency band that differs from the first frequency band, a beam sweeping procedure using a first subset of beams from a set of multiple available beams to determine, based on the location information and the map information, one or more beams of the first subset of beams to be used for communication with the second wireless device. The communications manager 1220 is capable of, configured to, or operable to support a means for communicating, over the second frequency band, one or more messages with the second wireless device using the one or more beams of the first subset of beams.

Additionally, or alternatively, the communications manager 1220 may support wireless communications in accordance with examples as disclosed herein. For example, the communications manager 1220 is capable of, configured to, or operable to support a means for receiving, over a first frequency band, a first vehicle safety message including intersection information associated with an intersection including a set of multiple lanes, where the intersection information includes beam direction information associated with a subset of the set of multiple lanes. The communications manager 1220 is capable of, configured to, or operable to support a means for performing, with a second wireless device over a second frequency band that differs from the first frequency band, a beam sweeping procedure using a first subset of beams from a set of multiple available beams to determine, based on the intersection information, one or more beams of the first subset of beams to be used for communication with the second wireless device. The communications manager 1220 is capable of, configured to, or operable to support a means for communicating, over the second frequency band, one or more messages with the second wireless device using the one or more beams of the first subset of beams.

By including or configuring the communications manager 1220 in accordance with examples as described herein, the device 1205 may support techniques for improved communication reliability, reduced latency, improved user experience related to reduced processing, reduced power consumption, more efficient utilization of communication resources, improved coordination between devices, longer battery life, improved utilization of processing capability, or any combination thereof.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the at least one processor 1240, the at least one memory 1230, the code 1235, or any combination thereof. For example, the code 1235 may include instructions executable by the at least one processor 1240 to cause the device 1205 to perform various aspects of assisted beam management as described herein, or the at least one processor 1240 and the at least one memory 1230 may be otherwise configured to, individually or collectively, perform or support such operations.

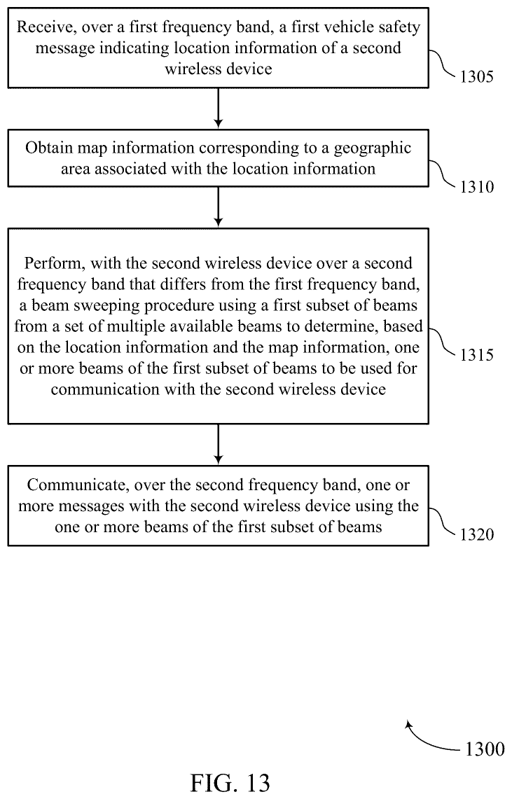

FIG. 13 shows a flowchart illustrating a method 1300 that supports assisted beam management in accordance with aspects of the present disclosure. The operations of the method 1300 may be implemented by a UE or its components as described herein. For example, the operations of the method 1300 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1305, the method may include receiving, over a first frequency band, a first vehicle safety message indicating location information of a second wireless device. The operations of block 1305 may be performed in accordance with examples as disclosed herein. In some examples, aspects of the operations of 1305 may be performed by a location information component 1125 as described with reference to FIG. 11.

At 1310, the method may include obtaining map information corresponding to a geographic area associated with the location information. The operations of block 1310 may be performed in accordance with examples as disclosed herein. In some examples, aspects of the operations of 1310 may be performed by a map information component 1130 as described with reference to FIG. 11.

At 1315, the method may include performing, with the second wireless device over a second frequency band that differs from the first frequency band, a beam sweeping procedure using a first subset of beams from a set of multiple available beams to determine, based on the location information and the map information, one or more beams of the first subset of beams to be used for communication with the second wireless device. The operations of block 1315 may be performed in accordance with examples as disclosed herein. In some examples, aspects of the operations of 1315 may be performed by a beam sweeping procedure component 1135 as described with reference to FIG. 11.

At 1320, the method may include communicating, over the second frequency band, one or more messages with the second wireless device using the one or more beams of the first subset of beams. The operations of block 1320 may be performed in accordance with examples as disclosed herein. In some examples, aspects of the operations of 1320 may be performed by a communication component 1140 as described with reference to FIG. 11.

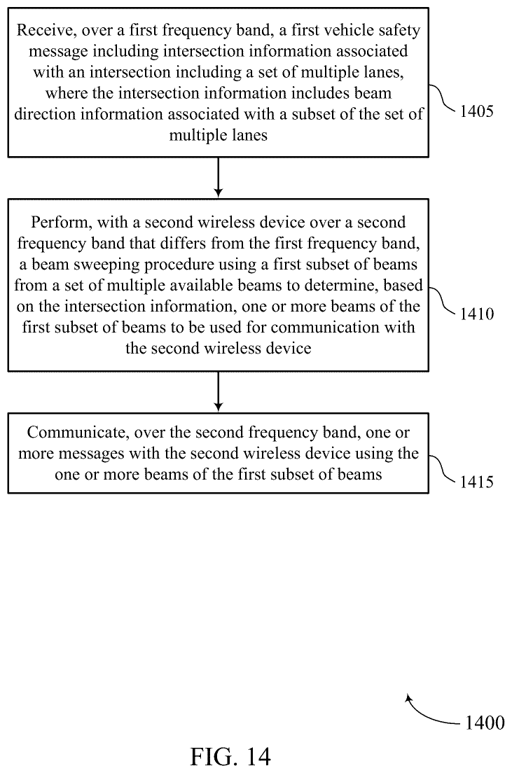

FIG. 14 shows a flowchart illustrating a method 1400 that supports assisted beam management in accordance with aspects of the present disclosure. The operations of the method 1400 may be implemented by a UE or its components as described herein. For example, the operations of the method 1400 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1405, the method may include receiving, over a first frequency band, a first vehicle safety message including intersection information associated with an intersection including a set of multiple lanes, where the intersection information includes beam direction information associated with a subset of the set of multiple lanes. The operations of block 1405 may be performed in accordance with examples as disclosed herein. In some examples, aspects of the operations of 1405 may be performed by an intersection information component 1145 as described with reference to FIG. 11.

At 1410, the method may include performing, with a second wireless device over a second frequency band that differs from the first frequency band, a beam sweeping procedure using a first subset of beams from a set of multiple available beams to determine, based on the intersection information, one or more beams of the first subset of beams to be used for communication with the second wireless device. The operations of block 1410 may be performed in accordance with examples as disclosed herein. In some examples, aspects of the operations of 1410 may be performed by a beam sweeping procedure component 1135 as described with reference to FIG. 11.

At 1415, the method may include communicating, over the second frequency band, one or more messages with the second wireless device using the one or more beams of the first subset of beams. The operations of block 1415 may be performed in accordance with examples as disclosed herein. In some examples, aspects of the operations of 1415 may be performed by a communication component 1140 as described with reference to FIG. 11.

The following provides an overview of aspects of the present disclosure:

Aspect 1: A method for wireless communications at a first wireless device, comprising: receiving, over a first frequency band, a first vehicle safety message indicating location information of a second wireless device; obtaining map information corresponding to a geographic area associated with the location information; performing, with the second wireless device over a second frequency band that differs from the first frequency band, a beam sweeping procedure using a first subset of beams from a plurality of available beams to determine, based at least in part on the location information and the map information, one or more beams of the first subset of beams to be used for communication with the second wireless device; and communicating, over the second frequency band, one or more messages with the second wireless device using the one or more beams of the first subset of beams.

Aspect 2: The method of aspect 1, further comprising: receiving, over the first frequency band from the second wireless device, a first message comprising intersection information associated with an intersection comprising a plurality of lanes, wherein the intersection information comprises beam direction information associated with a subset of the plurality of lanes; wherein performing the beam sweeping procedure is based at least in part on the intersection information.

Aspect 3: The method of any of aspects 1 through 2, further comprising: receiving the map information from the second wireless device.

Aspect 4: The method of any of aspects 1 through 3, wherein the first wireless device is an on-board unit (OBU) and the second wireless device is a network entity co-located with a road-side unit.

Aspect 5: The method of any of aspects 1 through 4, wherein the first wireless device is a first on-board unit (OBU) associated with a first vehicle and the second wireless device is a second OBU associated with a second vehicle.

Aspect 6: The method of any of aspects 1 through 5, wherein the first frequency band is an intelligent transportation system (ITS) band.

Aspect 7: The method of any of aspects 1 through 6, wherein the second frequency band is a millimeter wave band.

Aspect 8: A method for wireless communications at a first wireless device, comprising: receiving, over a first frequency band, a first vehicle safety message comprising intersection information associated with an intersection comprising a plurality of lanes, wherein the intersection information comprises beam direction information associated with a subset of the plurality of lanes; performing, with a second wireless device over a second frequency band that differs from the first frequency band, a beam sweeping procedure using a first subset of beams from a plurality of available beams to determine, based at least in part on the intersection information, one or more beams of the first subset of beams to be used for communication with the second wireless device; and communicating, over the second frequency band, one or more messages with the second wireless device using the one or more beams of the first subset of beams.

Aspect 9: The method of aspect 8, further comprising: receiving, over the first frequency band, a second vehicle safety message indicating location information of the second wireless device; and obtaining map information corresponding to a geographic area associated with the location information; wherein performing the beam sweeping procedure is based at least in part on the location information and the map information.

Aspect 10: The method of any of aspects 8 through 9, wherein the first vehicle safety message is a signal phase and time message, a map data message, or a road geometry attributes message.

Aspect 11: The method of any of aspects 8 through 10, wherein the first vehicle safety message comprises a beam quantity parameter indicating a plurality of beams, a beam azimuth angle parameter for each beam of the plurality of beams, a beam elevation parameter for each beam of the plurality of beams, a current beam parameter for the subset of the plurality of lanes, or any combination thereof.

Aspect 12: The method of aspect 11, wherein the current beam parameter is associated with a lane connection parameter that is associated with the subset of the plurality of lanes, wherein performing the beam sweeping procedure is based at least in part on the current beam parameter.

Aspect 13: The method of any of aspects 8 through 12, further comprising: performing the beam sweeping procedure based at least in part on the subset of the plurality of lanes corresponding to a first vehicle associated with the first wireless device, wherein the subset of the plurality of lanes corresponds to the first subset of beams.

Aspect 14: The method of any of aspects 8 through 13, wherein the first vehicle safety message comprises a plurality of identifiers associated with the plurality of available beams; and the one or more beams of the first subset of beams are determined based at least in part on corresponding identifiers of the plurality of identifiers.

Aspect 15: The method of any of aspects 8 through 14, wherein the first wireless device is an on-board unit (OBU) and the second wireless device is a network entity co-located with a road-side unit.

Aspect 16: The method of any of aspects 8 through 15, wherein the first vehicle safety message indicates a public land mobile network (PLMN) identifier associated with the second wireless device.

Aspect 17: The method of any of aspects 8 through 16, wherein the first frequency band is an intelligent transportation system (ITS) band.

Aspect 18: The method of any of aspects 8 through 17, wherein the second frequency band is a millimeter wave band.

Aspect 19: A first wireless device for wireless communications, comprising one or more memories storing processor-executable code, and one or more processors coupled with the one or more memories and individually or collectively operable to execute the code to cause the first wireless device to perform a method of any of aspects 1 through 7.

Aspect 20: A first wireless device for wireless communications, comprising at least one means for performing a method of any of aspects 1 through 7.

Aspect 21: A non-transitory computer-readable medium storing code for wireless communications, the code comprising instructions executable by one or more processors to perform a method of any of aspects 1 through 7.

Aspect 22: A first wireless device for wireless communications, comprising one or more memories storing processor-executable code, and one or more processors coupled with the one or more memories and individually or collectively operable to execute the code to cause the first wireless device to perform a method of any of aspects 8 through 18.

Aspect 23: A first wireless device for wireless communications, comprising at least one means for performing a method of any of aspects 8 through 18.

Aspect 24: A non-transitory computer-readable medium storing code for wireless communications, the code comprising instructions executable by one or more processors to perform a method of any of aspects 8 through 18.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first wireless device, comprising:
one or more memories storing processor-executable code; and
one or more processors coupled with the one or more memories and individually or collectively operable to execute the code to cause the first wireless device to:
receive, over a first frequency band, a first vehicle safety message indicating location information of a second wireless device;
obtain map information corresponding to a geographic area associated with the location information;
perform, with the second wireless device over a second frequency band that differs from the first frequency band, a beam sweeping procedure using a first subset of beams from a plurality of available beams to determine, based at least in part on the location information and the map information, one or more beams of the first subset of beams to be used for communication with the second wireless device; and
communicate, over the second frequency band, one or more messages with the second wireless device using the one or more beams of the first subset of beams.

2. The first wireless device of claim 1, wherein the one or more processors are individually or collectively further operable to execute the code to cause the first wireless device to:
receive, over the first frequency band from the second wireless device, a first message comprising intersection information associated with an intersection comprising a plurality of lanes, wherein the intersection information comprises beam direction information associated with a subset of the plurality of lanes;
wherein performing the beam sweeping procedure is based at least in part on the intersection information.

3. The first wireless device of claim 1, wherein the one or more processors are individually or collectively further operable to execute the code to cause the first wireless device to:
receive the map information from the second wireless device.

4. The first wireless device of claim 1, wherein the first wireless device is an on-board unit (OBU) and the second wireless device is a network entity co-located with a road-side unit.

5. The first wireless device of claim 1, wherein the first wireless device is a first on-board unit (OBU) associated with a first vehicle and the second wireless device is a second OBU associated with a second vehicle.

6. The first wireless device of claim 1, wherein the first frequency band is an intelligent transportation system (ITS) band.

7. The first wireless device of claim 1, wherein the second frequency band is a millimeter wave band.

8. A first wireless device, comprising:
one or more memories storing processor-executable code; and
one or more processors coupled with the one or more memories and individually or collectively operable to execute the code to cause the first wireless device to:
receive, over a first frequency band, a first vehicle safety message comprising intersection information associated with an intersection comprising a plurality of lanes, wherein the intersection information comprises beam direction information associated with a subset of the plurality of lanes;
perform, with a second wireless device over a second frequency band that differs from the first frequency band, a beam sweeping procedure using a first subset of beams from a plurality of available beams to determine, based at least in part on the intersection information, one or more beams of the first subset of beams to be used for communication with the second wireless device; and
communicate, over the second frequency band, one or more messages with the second wireless device using the one or more beams of the first subset of beams.

9. The first wireless device of claim 8, wherein the one or more processors are individually or collectively further operable to execute the code to cause the first wireless device to:
receive, over the first frequency band, a second vehicle safety message indicating location information of the second wireless device; and
obtain map information corresponding to a geographic area associated with the location information;
wherein performing the beam sweeping procedure is based at least in part on the location information and the map information.

10. The first wireless device of claim 8, wherein the first vehicle safety message is a signal phase and time message, a map data message, or a road geometry attributes message.

11. The first wireless device of claim 8, wherein the first vehicle safety message comprises a beam quantity parameter indicating a plurality of beams, a beam azimuth angle parameter for each beam of the plurality of beams, a beam elevation parameter for each beam of the plurality of beams, a current beam parameter for the subset of the plurality of lanes, or any combination thereof.

12. The first wireless device of claim 11, wherein the current beam parameter is associated with a lane connection parameter that is associated with the subset of the plurality of lanes, and wherein performing the beam sweeping procedure is based at least in part on the current beam parameter.

13. The first wireless device of claim 8, wherein the one or more processors are individually or collectively further operable to execute the code to cause the first wireless device to:
perform the beam sweeping procedure based at least in part on the subset of the plurality of lanes corresponding to a first vehicle associated with the first wireless device, wherein the subset of the plurality of lanes corresponds to the first subset of beams.

14. The first wireless device of claim 8, wherein:
the first vehicle safety message comprises a plurality of identifiers associated with the plurality of available beams; and
the one or more beams of the first subset of beams are determined based at least in part on corresponding identifiers of the plurality of identifiers.

15. The first wireless device of claim 8, wherein the first wireless device is an on-board unit (OBU) and the second wireless device is a network entity co-located with a road-side unit.

16. The first wireless device of claim 8, wherein the first vehicle safety message indicates a public land mobile network (PLMN) identifier associated with the second wireless device.

17. The first wireless device of claim 8, wherein the first frequency band is an intelligent transportation system (ITS) band.

18. The first wireless device of claim 8, wherein the second frequency band is a millimeter wave band.

19. A method for wireless communications at a first wireless device, comprising:
receiving, over a first frequency band, a first vehicle safety message indicating location information of a second wireless device;
obtaining map information corresponding to a geographic area associated with the location information;
performing, with the second wireless device over a second frequency band that differs from the first frequency band, a beam sweeping procedure using a first subset of beams from a plurality of available beams to determine, based at least in part on the location information and the map information, one or more beams of the first subset of beams to be used for communication with the second wireless device; and
communicating, over the second frequency band, one or more messages with the second wireless device using the one or more beams of the first subset of beams.

20. The method of claim 19, further comprising:
receiving, over the first frequency band from the second wireless device, a first message comprising intersection information associated with an intersection comprising a plurality of lanes, wherein the intersection information comprises beam direction information associated with a subset of the plurality of lanes;
wherein performing the beam sweeping procedure is based at least in part on the intersection information.

21. The method of claim 19, wherein the first wireless device is an on-board unit (OBU) and the second wireless device is a network entity co-located with a road-side unit.

22. The method of claim 19, wherein the first wireless device is a first on-board unit (OBU) associated with a first vehicle and the second wireless device is a second OBU associated with a second vehicle.

23. A method for wireless communications at a first wireless device, comprising:
receiving, over a first frequency band, a first vehicle safety message comprising intersection information associated with an intersection comprising a plurality of lanes, wherein the intersection information comprises beam direction information associated with a subset of the plurality of lanes;
performing, with a second wireless device over a second frequency band that differs from the first frequency band, a beam sweeping procedure using a first subset of beams from a plurality of available beams to determine, based at least in part on the intersection information, one or more beams of the first subset of beams to be used for communication with the second wireless device; and
communicating, over the second frequency band, one or more messages with the second wireless device using the one or more beams of the first subset of beams.

24. The method of claim 23, further comprising:
receiving, over the first frequency band, a second vehicle safety message indicating location information of the second wireless device; and
obtaining map information corresponding to a geographic area associated with the location information;
wherein performing the beam sweeping procedure is based at least in part on the location information and the map information.

25. The method of claim 23, wherein the first vehicle safety message is a signal phase and time message, a map data message, or a road geometry attributes message.

26. The method of claim 23, wherein the first vehicle safety message comprises a beam quantity parameter indicating a plurality of beams, a beam azimuth angle parameter for each beam of the plurality of beams, a beam elevation parameter for each beam of the plurality of beams, a current beam parameter for the subset of the plurality of lanes, or any combination thereof.

27. The method of claim 26, wherein the current beam parameter is associated with a lane connection parameter that is associated with the subset of the plurality of lanes, and wherein performing the beam sweeping procedure is based at least in part on the current beam parameter.

28. The method of claim 23, further comprising:
performing the beam sweeping procedure based at least in part on the subset of the plurality of lanes corresponding to a first vehicle associated with the first wireless device, wherein the subset of the plurality of lanes corresponds to the first subset of beams.

29. The method of claim 23, wherein:
the first vehicle safety message comprises a plurality of identifiers associated with the plurality of available beams; and
the one or more beams of the first subset of beams are determined based at least in part on corresponding identifiers of the plurality of identifiers.

30. The method of claim 23, wherein the first vehicle safety message indicates a public land mobile network (PLMN) identifier associated with the second wireless device.
